(19) United States
(12) Patent Application Publication
(10) Pub. No.: US 2024/0426002 A1
(43) Pub. Date: Dec. 26, 2024

(54) NANOSTRUCTURED ELECTRODES

(71) Applicant: TECHNION RESEARCH & DEVELOPMENT FOUNDATION LIMITED, Haifa (IL)

(72) Inventors: Charlotte VOGT, Haifa (IL); Noam ZISSER GAL, Haifa (IL); Noam KARO, Haifa (IL); Or MAYRAZ, Haifa (IL); Assaf LICHT, Haifa (IL)

(21) Appl. No.: 18/829,609

(22) Filed: Sep. 10, 2024

Related U.S. Application Data
(63) Continuation of application No. PCT/IL2023/050256, filed on Mar. 13, 2023.
(60) Provisional application No. 63/319,332, filed on Mar. 13, 2022.
(60) Provisional application No. 63/392,538, filed on Jul. 27, 2022.

(51) Int. Cl. C25B 11/037; B22F 1/054; B22F 9/14; C02F 1/46; C02F 1/461; C02F 1/66; C25B 1/04; C25B 11/052; C25B 11/054; C25B 11/061; C25B 11/067; C25B 11/089; C25B 11/091; C25B 13/07; H01M 4/88; H01M 4/90

(52) U.S. Cl. CPC C25B 11/037; B22F 1/054; B22F 9/14; C02F 1/4602; C02F 1/46109; C02F 1/66; C25B 1/04; C25B 11/052; C25B 11/054; C25B 11/061; C25B 11/067; C25B 11/089; C25B 11/091; C25B 13/07; H01M 4/881; H01M 4/9016; H01M 4/905; H01M 4/9075; B22F 2301/35; B22F 2304/054; B22F 2998/10; B22F 2999/00; C02F 2001/46142

(57) ABSTRACT

Nanostructured electrodes comprising nanoparticles of conductive material deposited on a conductive electrode support are described in the present invention. Said nanoparticles are characterised by a particle size of about 20.0 nm or less and a particle size distribution having a tuneable standard deviation from ±0.1 nm to ±1.0 nm. This particle size distribution is measured using a differential mobility analyser. The nanostructured electrodes are manufactured by the method of spark ablation, which provides a scalable and viable way for producing widely different types of mixed nanoparticles. Most importantly, implementation of the spark ablation has the great advantage to combine a wider range of materials, thereby allowing the synthesis of mixed nanoparticles with virtually unlimited combinations and highly sharp particle size distribution control which is advantageous for high tunability of selectivity.

### CROSS REFERENCE TO RELATED APPLICATIONS

This application is a Bypass Continuation of PCT Patent Application No. PCT/IL2023/050256 having International filing date of Mar. 13, 2023, which claims the benefit of priority of U.S. Provisional Patent Application Nos. 63/319,332, filed Mar. 13, 2022, and 63/392,538, filed Jul. 27, 2022, the contents of which are all incorporated herein by reference in their entirety.

### TECHNICAL FIELD

The present application relates to the field of nanotechnology. In particular, the present application relates to nanostructured electrodes manufactured by the method of spark ablation and their use in solid oxide electrolyser cells.

### BACKGROUND

To mitigate the worst effects of climate change, a radical modification of our energy system is required: a shift from fossil fuels to low-carbon energy sources. The problem is not the amount of renewable energy available—the energy potential of the sun and wind is many times greater than the world's energy consumption. Rather, the key to a 100 percent renewable energy supply lies in integrating a growing share of intermittent sources into an energy infrastructure that can meet constant demand. The higher the share of renewable energy sources, the more flexible and interconnected the energy system should be (electricity networks, gas and heat networks, etc.). Critically, the future energy system, in which the supply of electricity, heat and fuel is based largely or even solely on renewable energy sources, is critically dependent on technologies that can convert electricity into chemicals and fuels suitable for heavy transport with high efficiency. In addition, higher electrolysis efficiency and integrated fuel generation can reduce dependence on fossil fuels to a greater extent than with conventional electrolysis.

In a world powered by intermittent renewable energy, electrolysers will play a central role in converting electrical energy into chemical energy, thereby separating the production of transportation fuels and chemicals from today's fossil resources.

Currently, thermal catalysis accounts for approximately ⅓ of the world's gross domestic product. Several main areas can be distinguished: energy (e.g., oil refining), materials, fine chemicals (e.g., drugs) and food production. The gradual transition of society from fossil fuels to sustainable energy means that most of the energy that we will now collect will be in the form of electrons, and will not be obtained by burning hydrocarbons contained in fossil fuels. The inevitable reality of cheap and widely available sustainable electricity has increased interest in developing these major electricity markets. Electrosynthesis, which is defined as a synthesis or transformation of chemical compounds driven by electrons, can play a big role in the chemical industry (±5.4 TUSD per year).

An additional reason for this is the possibility of more accurate control of the input of energy (via current or electrode potential) than is possible with currently used thermal methods. This allows for reactions that are not possible with thermal catalysis. However, wide industrial application is not yet possible due to high operating and/or capital costs.

Solid oxide electrolysis cells (SOECs) offer two major advantages over alternative electrolysis technologies. First, their high operating temperatures result in favourable thermodynamics and reaction kinetics, providing unsurpassed conversion efficiency. Secondly, the solid oxide electrolysis cells (SOECs) can be thermally integrated with downstream chemical syntheses, such as the production of methanol, dimethyl ether, synthetic fuels, or ammonia.

SOECs consist of three main components: two porous electrodes and a dense ceramic electrolyte capable of conducting oxide ions (O₂⁻). SOECs are capable of effectively splitting steam and CO₂ into H₂ and CO, but can also operate in co-electrolysis mode, converting the carbon dioxide-water mixture directly into synthesis gas (syngas; CO+H₂). The electrochemical reduction of H₂O and/or CO₂ occurs at the negatively charged fuel electrode, and the oxide ions are transferred through the solid electrolyte to the positively charged oxygen electrode, where they recombine oxidatively into the gaseous O₂ phase.

When operated in reverse, the SOEC acts as a solid oxide fuel cell (SOFC). Compared to current technologies such as polymer exchange membranes (PEMs), electrolysers operating at a thermoneutral potential for water splitting (1.47 V) achieve current densities of ±0.5 A/cm², whereas the SOFCs can theoretically operate at a current density of ±1.5 A/cm² at a thermoneutral potential for steam splitting (1.29 V). Lower cell voltage is directly related to lower operating costs (lower electricity demand per amount of gas produced), while higher current density is associated with lower capital costs (fewer electrolysers are required to achieve the required gas production). Thus, large-scale application of SOEC is economically preferable to other types of cells.

### SUMMARY

The present invention describes embodiments of nanostructured electrodes comprising nanoparticles of conductive material deposited on a conductive electrode support, wherein said nanoparticles are characterised by a particle size of about 20.0 nm or less and a particle size distribution having a tuneable standard deviation from ±0.1 nm to ±1.0 nm. This particle size distribution is measured using a differential mobility analyser. The nanostructured electrodes are manufactured by the method of spark ablation, which provides a scalable and viable way for producing widely different types of mixed nanoparticles. Most importantly, implementation of the spark ablation has the great advantage to combine a wider range of materials, thereby allowing the synthesis of mixed nanoparticles with virtually unlimited combinations and highly sharp particle size distribution control which is advantageous for high tunability of selectivity. The present invention is not limited to particular materials of the electrodes prepared by this method. Non-limiting examples of the materials described in the present invention are yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel.

The present invention exemplifies the aforelisted types of nanostructured (NS) electrodes used in different applications. Non-limiting examples of these electrodes are electrodes comprising nickel nanoparticles supported on a nanostructured yttria-stabilized zirconia (Ni@YSZ) and their use in solid oxide electrolysers, and nanostructured stainless-steel electrodes and their use in several related applications. All nanostructured electrodes comprising the aforelisted materials and stainless steel are produced by the method of spark ablation.

In one embodiment, a nanostructured electrode comprises nanoparticles of conductive material deposited on a conductive electrode support, wherein said nanoparticles are characterised by a particle size of about 20 nm or less and a particle size distribution having a tuneable standard deviation from ±0.1 nm to ±1.0 nm, wherein said particle size is measured with a differential mobility analyser configured to select particle sizes, and said tuneable standard deviation is obtained by tuning a sheath flow rate of a carrier gas in the range of approximately 1 ml/min to 25 ml/min in said differential mobility analyser, thereby tuning the standard deviation of Gaussian distribution of the nanoparticle sizes from approximately ±0.1 nm to approximately ±2 nm.

Said nanostructured electrode is manufactured by the method of spark ablation, with a tuneable standard deviation from ±0.1 nm to ±1 nm provided by the addition of a differential mobility analyser to the electrode production setup. Said conductive material of the nanoparticles is selected from yttrium (Y), zirconia (Zr), zirconia stabilised with yttrium (YSZ), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel. In a specific embodiment, the nanoparticles are composite nanoparticles comprised of nickel supported on yttria-stabilized zirconia (Ni@YSZ). In another specific embodiment, the nanoparticles are stainless steel nanoparticles. In some embodiments, the conductive electrode support is a solid oxide membrane.

In a particular embodiment, the particle size of said nanoparticles is about 10 nm or less, or about 5 nm or less.

The nanostructured electrode of the present invention, when produced by the method of spark ablation, optionally has a surface covered with plurality of craters, said craters are defined as circular or oval-shaped corrugations having a valley surrounding the nanoparticle leading to an apex in height of up to 5 nm, to the likeness of a meteor impact, in which the nanoparticle sits, with the corrugation having a diameter of up to 3 times the diameter of the nanoparticle as measured by an atomic for microscope. Optionally, the nanoparticles covering the nanostructured electrode have a disk-like shape with a ratio of height to base of said disc being lower than 0.5, and down to 0.05 as measured by an atomic for microscope. Further the nanoparticles may be stacked or multi-layered over the surface of the electrode. These parameters relating to the shape of the nanoparticles, their surface features and arrangement over the surface of the nanostructured electrodes were confirmed using atomic force microscope (AFM).

In a further embodiment of the present invention, a solid oxide electrolyser or a fuel cell comprises the nanostructured electrode of the present invention. In some embodiments, the nanostructured electrode of the present invention is used in a method for electrochemical precipitation of salts from water and electrochemical scale removal. In a specific embodiment, said electrochemical scale removal is descaling of water for private and commercial purposes or water pre-treatment for water desalination. In still another embodiment, the nanostructured electrode of the present invention is used selectively increasing the pH of water.

Various embodiments may allow various benefits and may be used in conjunction with various applications. The details of one or more embodiments are set forth in the accompanying figures and the description below.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

Disclosed embodiments will be understood and appreciated more fully from the following detailed description taken in conjunction with the appended figures. The drawings included and described herein are schematic and are not limiting the scope of the disclosure. It is also noted that in the drawings, the size of some elements may be exaggerated and, therefore, not drawn to scale for illustrative purposes. The dimensions and the relative dimensions do not necessarily correspond to actual reductions to practice of the disclosure.

FIG. 1 shows the scanning electron micrograph of a catalyst prepared by the method of incipient wetness impregnation, 5 wt % Ni-YSZ. Nickel nanoparticles (±20 nm) are visible over micron particles of zirconia stabilised with yttrium.

FIG. 2 shows a schematic of a procedure by which nanoclusters/particles are formed and transported in an aerosol with a carrier gas such as argon by ablation of two conductive metal feed electrodes (e.g., nickel).

FIG. 3 schematically shows a differential mobility analyser that allows selection of nanoparticle sizes with an accuracy of 0.1 nm.

FIG. 4 schematically shows available electrolysers.

FIG. 5 schematically shows the various relevance scales associated with solid oxide electrolysers and their inclusion in a renewable energy storage scenario.

FIG. 6 schematically shows a repeating cell unit of a solid oxide electrolyser cell, prepared by wet chemistry methods.

FIG. 7a shows the recorded AFM image of a typical deposition of copper nanoparticles (9 nm) on a mica sheet. The larger “craters” on the surface of the mica are caused by the impaction of the nanoparticles over the mica.

FIG. 7b shows the recorded AFM image of the same sample as in FIG. 7a displaying the phase detector channel, where the black spots indicate a different material between the support and the nanoparticles.

FIG. 7c shows the topography AFM image showing the profile of the “craters” created upon impact to the mica.

FIG. 8 shows the AFM image of the deposition of platinum (Pt) nanoparticles (>10 nm) on a mica sheet showing the monodispersity in the height (±0.1 nm) of the nanoparticles, and low aspect ratio, in the height profile created using high sheath flow and high-speed impaction.

FIG. 9 shows the histogram of 117 counted Cu nanoparticle sizes by TEM analysis for a deposition with low sheath flow, for nanoparticles with a mean diameter of 5.9±0.9 nm.

FIG. 10 schematically shows the electrode produced by the wet-chemistry method versus the nanostructured electrode of the present invention. On the left is the electrode prepared by incipient wetness impregnation (IWI), where the YSZ particles are on the order of a micron, with a porous structure on which Ni nanoparticles can be observed in the TEM-EDX image showing Zr and Ni. On the right, the small-scale topography of the nanostructured (NS) electrode of the present invention measured by atomic force microscopy (AFM).

FIG. 11 shows a histogram of the current density (measured current normalised to exposed electrode surface) for chronoamperometry experiments with the YSZ-Ni nanostructured electrode of the present invention compared to an ink-based electrode prepared by the incipient wetness impregnation method.

FIGS. 12a-12b show electrochemical characterisation and comparison by cyclic voltammetry of the IWI electrode and the nano-structured (NS) Ni@YSZ electrode of the present invention.

FIG. 12a shows the comparative electrochemical activity of both IWI and NS electrodes in a pure H₂ production mode (water splitting, water is converted to hydrogen).

FIG. 12b shows the comparative electrochemical activity of both IWI and NS electrodes in an operating combined supply mode, in which CO₂ is co-fed with water (both are converted).

FIGS. 13a-13b show electrochemical characterisation by cyclic voltammetry for the preliminary stability of the NS electrode of the present invention.

FIG. 13a shows the cyclic voltammetry for the preliminary stability of the NS electrode of the present invention in a pure H₂ production mode (water splitting, water is converted to hydrogen).

FIG. 13b shows the cyclic voltammetry for the preliminary stability of the NS electrode of the present invention in an operating combined supply mode, in which CO₂ is co-fed with water (both are converted).

FIGS. 14a-14b show electrochemical characterisation by cyclic voltammetry for the preliminary stability of the IWI electrode.

FIG. 14a shows the cyclic voltammetry for the preliminary stability of the IWI electrode in a pure H₂ production mode (water splitting, water is converted to hydrogen).

FIG. 14b shows the cyclic voltammetry for the preliminary stability of the IWI electrode in an operating combined supply mode, in which CO₂ is co-fed with water (both are converted).

FIG. 15 shows a high-resolution scanning electron microscopy image of the nanostructured electrode of the present invention. The little white dots can be (barely), which are the nanostructure.

FIG. 16 shows the atomic force microscopy images showing the small-scale topography of the nanostructured electrode of the present invention created by spark ablation.

FIG. 17a shows the images of the 5 wt % Ni-YSZ powder, which was used in the preparation of the IWI electrode. These images are made with the transmission electron microscopy-electron diffraction X-rays (TEM-EDX).

FIG. 17b shows the granulometry analysis in the histogram of the Ni particle size distribution. The average particle size measured is 8.6 nm, the median particle size is 6.7 nm.

FIG. 18 shows the high-resolution scanning electron microscopy (HR-SEM) images of the 5 wt % Ni-YSZ powder used to prepare the IWI electrode.

FIG. 19 is a schematic overview of the mechanisms of electrochemical precipitation of calcium carbonate.

FIG. 20 shows a block diagram including a membrane cell system for electrochemical precipitation and a crystalliser, in which the alkaline feedstock comes into contact with calcium carbonate crystals and precipitation begins.

FIGS. 21 and 22 shows the stainless-steel material and the nanostructured stainless-steel material produced by the spark ablation technique for the creation of a nanostructured electrode of the present invention, respectively.

FIG. 23a shows cyclic voltammograms of a conventional stainless-steel electrode in the electrochemical precipitation of CaCO₃ in synthetic seawater.

FIG. 23b shows cyclic voltammograms of a nanostructured stainless-steel electrode of the present invention in the electrochemical precipitation of CaCO₃ in synthetic seawater.

FIG. 24a shows the comparative cyclic voltammogram of a nanostructured stainless-steel electrode with 9.5% coverage versus the cyclic voltammogram of a conventional stainless-steel electrode (red line) in the electrochemical precipitation of CaCO₃ in synthetic seawater.

FIG. 24b shows the comparative cyclic voltammogram of a nanostructured stainless-steel electrode with 9.5% coverage normalised to 100% coverage versus the cyclic voltammogram of a conventional stainless-steel electrode in the electrochemical precipitation of CaCO₃ in synthetic seawater.

FIG. 25 shows the HR-TEM micrograph of nanoparticles deposited on SiN TEM grid to analyse the size and shape of these deposited nanoparticles.

FIGS. 26a-26d shows scanning electron microscopy images of nanostructured composite materials of the present invention:

FIG. 26a: Yttrium-stabilized zirconia, molecular ratio metals 8:92 (YSZ);

FIG. 26b: Lanthanum strontium cobaltite, molecular ratio metals 4:1:5 (LSC);

FIG. 26c: Lanthanum strontium manganite, molecular ratio metals 40:10:50 (LSM); and

FIG. 26d: Lanthanum strontium cobalt ferrite, molecular ratio metals 1:5:3:3 (LSCF).

FIG. 27 shows cyclic voltammograms of nanostructured stainless steel on glassy carbon, and stainless-steel supports, and a reference of stainless steel with no nanoparticles of stainless steel.

### DETAILED DESCRIPTION

In the following description, various aspects of the present application will be described. For purposes of explanation, specific configurations and details are set forth in order to provide a thorough understanding of the present application. However, it will also be apparent to one skilled in the art that the present application may be practiced without the specific details presented herein. Furthermore, well-known features may be omitted or simplified in order not to obscure the present application.

The term “comprising”, used in the claims, is “open ended” and means the elements recited, or their equivalent in structure or function, plus any other element or elements which are not recited. It should not be interpreted as being restricted to the means listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising x and z” should not be limited to devices consisting only of components x and z. Also, the scope of the expression “a method comprising the steps x and z” should not be limited to methods consisting only of these steps.

Unless specifically stated, as used herein, the term “about” is understood as within a range of normal tolerance in the art, for example within two standard deviations of the mean. In one embodiment, the term “about” means within 10% of the reported numerical value of the number with which it is being used, preferably within 5% of the reported numerical value. For example, the term “about” can be immediately understood as within 10%, 9%, 8%, 7%, 6%, 5%, 4%, 3%, 2%, 1%, 0.5%, 0.1%, 0.05%, or 0.01% of the stated value. In other embodiments, the term “about” can mean a higher tolerance of variation depending on for instance the experimental technique used. Said variations of a specified value are understood by the skilled person and are within the context of the present invention. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges, for example from 1-3, from 2-4, and from 3-5, as well as 1, 2, 3, 4, 5, or 6, individually. This same principle applies to ranges reciting only one numerical value as a minimum or a maximum. Unless otherwise clear from context, all numerical values provided herein are modified by the term “about”. Other similar terms, such as “substantially”, “generally”, “up to” and the like are to be construed as modifying a term or value such that it is not an absolute. Such terms will be defined by the circumstances and the terms that they modify as those terms are understood by those of skilled in the art. This includes, at very least, the degree of expected experimental error, technical error and instrumental error for a given experiment, technique or an instrument used to measure a value.

As used herein, the term “and/or” includes any and all combinations of one or more of the associated listed items. Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that when an element is referred to as being “on”, “attached to”, “connected to”, “coupled with”, “contacting”, etc., another element, it can be directly on, attached to, connected to, coupled with or contacting the other element or intervening elements may also be present. In contrast, when an element is referred to as being, for example, “directly on”, “directly attached to”, “directly connected to”, “directly coupled” with or “directly contacting” another element, there are no intervening elements present. It will also be appreciated by those of skill in the art that references to a structure or feature that is disposed “adjacent” another feature may have portions that overlap or underlie the adjacent feature.

The present invention relates to a nanostructured electrode, a method for its manufacture and preparation of electrode compositions. The method for production (manufacturing) of the electrodes of the present invention is spark ablation, the main characteristics of which are the ability to control the size of nanoparticles with high accuracy and nanostructure of any conductive materials even below 20 nm.

In general, several different types of electrodes are known:
1. Gas diffusion electrodes.
2. Porous transport electrodes.
3. Catalyst-coated membranes.

Electrodes typically consist of active materials (often metals) on a conductive basis. Some common materials that make up electrodes are:
1. Nanoparticles of noble metals and alloys.
2. Core-shell nanoparticles in a continuous process.
3. Metal and mixed metal oxides.
4. Surface-modified carbon as a support.
5. Corrosion-resistant supports based on metal oxides or carbides.

The active materials of these electrodes act as catalysts, reducing the activation energy of chemical reactions and thereby speeding up their course. Since these active materials are often (expensive) metals, the main goal is to get as much active material surface area as possible for the same amount of material. It follows that this can be done by creating ever smaller nanoparticles. The smaller the nanoparticle, the higher the surface to volume ratio of the material, the greater the surface area per gram of metal used. More surface area results in more sites of activity, more electrochemically active surface area (ECSA). This yields higher activity per mass and often per unit volume of material, which is highly desirable.

However, when the particle size changes below about 10 nm, the nanoparticles may begin to exhibit an effect termed “structure sensitivity” where not all atoms of the nanoparticle have the same electrochemical reaction activity. This can give even more activity per unit mass/volume (or lower activity depending on the reaction) and the ability to tune this property is highly desirable but very difficult to achieve by traditional methods.

Electrode preparation methods use wet chemistry methods (including ink and ink application methods such as hot spray, drop casting), colloidal nanoparticle synthesis, wet impregnation, sputtering, and atomic layer deposition or chemical vapor deposition.

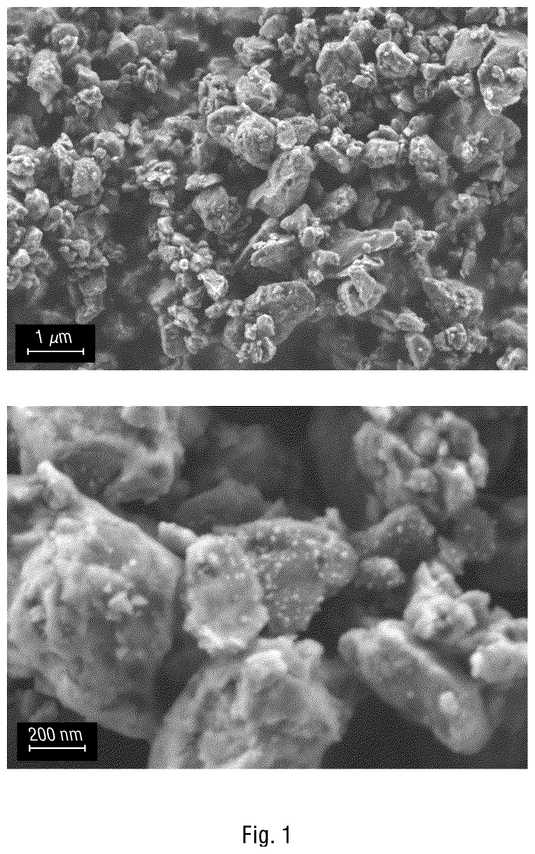

Electrode preparation procedures vary. The industry of preparing electrodes is dominated by wet chemistry methods that involve the separate synthesis of a catalyst material (e.g., metal nanoparticles on a conductive support) and subsequent deposition of this material onto a desired substrate, e.g., by spray-coating. Wet chemistry methods are easy to apply on a large scale, but they also provide less control over the morphology and size of materials, especially for metal oxides (metal oxide carrier particles are often micron-sized). FIG. 1 shows the scanning electron micrograph of a catalyst prepared by the method of incipient wetness impregnation, 5 wt % Ni-YSZ. Nickel nanoparticles (±20 nm) are visible over micron particles of zirconia stabilised with yttrium.

Sputtering is seen as a technique with great potential for the production of next generation electrodes because materials can be nanostructured, often providing greatly improved accuracy or geometric control. The physical limitations of this method are the structuring of the electrodes at the level of hundreds nm. Various electrodes and a solid oxide electrolyte prepared by sputtering to obtain a fine structure are of several hundred nm in size. Table 1 lists the various methods of making electrodes, as well as their advantages and disadvantages.

TABLE 1
Methods for the production of electrodes, their pros and cons.

| | | | Reported |
|---|---|---|---|
| | | | improvements |
| Method | Pros | Cons | on standard |
| CVD | Accuracy to | Slow and expensive, | 1 order of |
| | nm scale | only applicable in 2D | magnitude |
| ALD | Accuracy to | Slow and expensive, | 1 order of |
| | nm scale | only applicable in 2D | magnitude |
| Sputtering | Relatively | Accuracy down to | 1 order of |
| | fast/scalable | hundreds of | magnitude |
| | | nanometres | |
| Solution- | Scalable | Low control, YSZ | Standard |
| based | and cheap | mesoscale | |
| chemistry | | | |
| Spark | Extreme accuracy | Not known | This work; |
| ablation | (3D, single | | activity |
| | nanometres), | | improvements |
| | scalable, cheap. | | two orders of |
| | | | magnitude |

Spark ablation is a technique that has only recently become a commercial tool for laboratory research into nanoparticle production, largely due to the development of the tool and method by Dutch start-up company “VSParticle”. Spark ablation, in essence, is the application of a high potential difference between two conductive electrodes, which ensures that some of the material is removed (ablated) from these electrodes due to extremely high local temperatures.

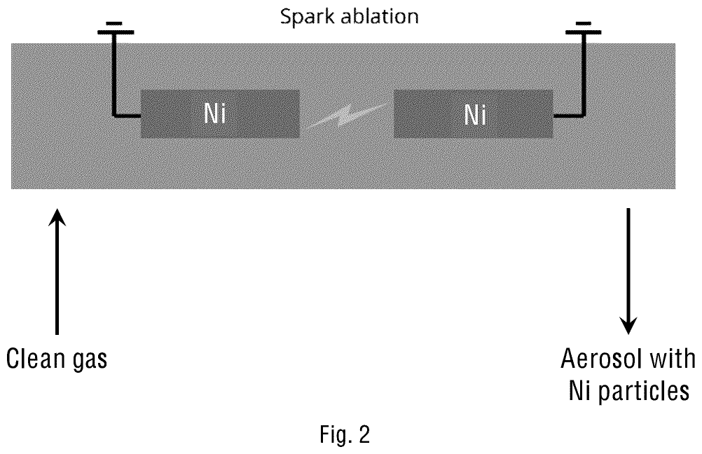

FIG. 2 shows a schematic of a procedure by which nanoclusters/particles are formed and transported in an aerosol with a carrier gas such as argon by ablation of two conductive metal feed electrodes (e.g., nickel), which are used in the present invention to create electrodes for electrochemistry. The clusters formed in this way are carried by a carrier gas, for example argon, in the gas phase, whereby they can be applied to several media. This can be done either with two electrodes of the same material (for example, 2 Ni electrodes), or with two electrodes of different materials (for example, 1 Ni electrode and 1 Fe electrode), and the procedure can be repeated as many times as desired to create the final composition of the material as desired.

By adjusting the flow rate of the carrier gas (velocity of the carrier gas), it is possible to increase or decrease the agglomeration time of nanoclusters in the feed. Therefore, it is possible, for example, to influence the Gaussian size distribution of nanoparticles in an aerosol generated by spark ablation at constant power applied to the electrode for various gas flow rates. By adjusting the potential (V) of the spark and the current (A) applied between the two electrodes, additional control can be achieved so that the deposition time of nanoparticles of the desired size can be adjusted.

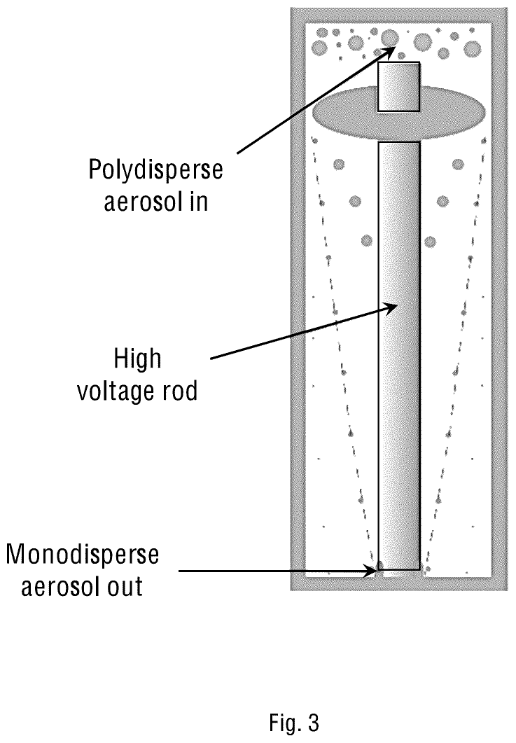

Finally, by adding a differential mobility analyser to the setup, one can add the ability to select the size of nanoparticles with an accuracy of ±0.1 nm for deposition. FIG. 3 schematically shows a differential mobility analyser that allows selection of nanoparticle sizes with an accuracy of ±0.1 nm. This is an optional addition, and the generated aerosol can also be completely deposited without choosing the size of the nanoparticles when a complete Gaussian size distribution of the nanoparticles is found on the substrate.

Creation of nanostructured 2D or 3D metal oxide layers for solid oxide electrolysers and solid oxide fuel cells with nanoparticles smaller than 20 nm from one, different and/or combinations of (ionic) conductive materials, such as yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel, which provide a significantly increased catalytic activity (e.g., current density or turnover frequency) achieved by three-phase boundary nano-structuring, spark ablation, and deposition or printing—in layers or as discrete shapes—on a two-dimensional or three-dimensional (conductive) support layer, or directly on a (solid oxide) membrane.

The transition of energy from fossil fuels to sustainable solutions such as renewable electricity, carbon-neutral or negative fuels and chemicals poses many challenges that need to be addressed in record time. One such challenge is the intermittent nature of renewable electricity sources such as wind and solar and the search for suitable, cheap and scalable energy storage solutions. Intermediate facilities that can convert energy into chemical products are needed to maintain a stable energy supply. Electricity from renewable sources will increasingly be used to meet society's ever-increasing demand for electricity in an attempt to move away from fossil fuels. In countries such as Denmark and Germany, intermittent power sources already account for up to 50% of the electricity supply and this proportion is expected to increase significantly. To sustain this trend, there is an urgent need for technological solutions that can convert and store energy on a sufficiently large scale, as the present inventors have recently found. Seasonal renewable electricity demand and supply demodulation in Europe is estimated at 480 TWh, or 15% of total demand, requiring energy buffers/carriers.

The present invention describes nanostructured electrodes comprising nanoparticles of conductive material deposited on a conductive electrode support, wherein said nanoparticles are characterised by a particle size of about 20 nm or less and a particle size distribution. These nanostructured electrodes are manufactured by the method of spark ablation, which provides a scalable and viable way for producing widely different types of mixed nanoparticles. The addition of a differential mobility analyser to the electrode production setup provides the opportunity to select a sharp particle size distribution, where the term “sharp” means that the particle size distribution is within a standard deviation between ±1 nm and ±0.1 nm. Most importantly, implementation of the spark ablation has the great advantage to combine a wider range of materials, thereby allowing the synthesis of mixed nanoparticles with virtually unlimited combinations. The present invention is not limited to particular materials of the electrodes prepared by this method. Non-limiting examples of the materials described in the present invention are yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel. The present invention exemplifies these types of nanostructured electrodes for use in different applications. The aforementioned nanostructured electrodes, for example, nickel-impregnated yttria-stabilised zirconia (Ni@YSZ) electrode or stainless-steel electrode, are produced by the method of spark ablation and used in solid oxide electrolysers, and several other applications.

Thus, the present specification is structured as follows. First, the NS Ni@YSZ electrode of the present invention and its use in solid oxide electrolysers are described. Second, the NS stainless-steel electrode and its uses in water descaling and electrochemical desalination procedures are described. Third, the preparation of nanostructured electrodes of different compositions is described.

In one aspect of the present invention, a nanostructured electrode comprises nanoparticles of conductive material deposited on a conductive electrode support, wherein said nanoparticles are characterised by a particle size of about 20.0 nm or less and a sharp particle size distribution with a tuneable standard deviation between ±1.0 nm and ±0.1 nm. This particle size distribution is measured using a differential mobility analyser.

As defined herein, the term “tuneable” with respect to the aforementioned standard deviation means that by altering the sheath flow rate of the carrier gas in the range of approximately 1 ml/min to 25 ml/min in the differential mobility analyser, which selects the particle sizes, the standard deviation of the Gaussian distribution of nanoparticle sizes is tuned from approximately ±0.1 to ±2 nm. Another parameter affecting the standard deviation of the Gaussian distribution of nanoparticle sizes that evolve from the differential mobility analyser, is the type of inert gas that is used as the aerosol carrier gas, e.g., Ar, versus N₂.

In one embodiment, said conductive material of the nanoparticles produced in the spark ablation process is selected from yttrium (Y), zirconia (Zr), zirconia stabilised with yttrium (YSZ), nickel and stainless steel. In a particular embodiment, said nanoparticles are nickel-impregnated yttria-stabilized zirconia (Ni@YSZ) composite nanoparticles. In another specific embodiment, said nanoparticles are stainless steel nanoparticles. In some embodiments, the conductive electrode support is a solid oxide membrane. In other embodiments, the particle size of the nanoparticles is about 10 nm or less, or about 5 nm or less.

### Solid Oxide Electrolysers (SOECs)

There is a long-felt need for large-scale renewable energy storage to mitigate anthropogenic climate change. Solid oxide electrolysers (SOECs), unlike many other typical systems, can solve this problem. However, this requires urgent development of improved CO₂ and H₂O conversion catalysts. Electrolysis plants with SOEC cells are capable of splitting steam (H₂O) and in some cases carbon dioxide. The resulting products, such as hydrogen (H₂), carbon monoxide (CO) or methane gas (CH₄), can serve as feedstock for the chemical or steel industry, as well as chemical storage mechanisms to stabilize the grid. Some possible uses include synthetic fuels that can be used to power heavy or long-haul transport (aircraft, ships and trucks) as a CO₂ zero-emission option (fuels made from CO₂ “waste” will be burned in a delocalised fashion and eventually emitted as CO₂), or can be used in sustainable building materials such as steel, or even as a chemical storage for renewable electricity.

SOECs can be thermally integrated with a range of chemical syntheses yielding synthetic natural gas or gasoline, methanol or (with nitrogen added) ammonia, resulting in further efficiency gains compared to low temperature electrolysis technologies. Modern solid oxide electrolysers are mainly made from yttrium-stabilized zirconia (YSZ). However, these catalysts are far from being optimized. The main problem, as with many electrocatalysts, is that fundamental understanding of how they work is severely lacking.

Another important issue is that the manufacturing procedures currently used in large-scale production yield sub-optimal micro structured materials. It is considered promising to increase the surface area of electrochemically active phases, for example, by atomic layer deposition (ALD) or pulsed laser deposition (PLD), since this increases the surface of the TFB (triple phase boundary), where electrically conductive and electrocatalytically active nickel, gas- and oxide-ion-conducting yttrium-stabilized zirconia (YSZ) meet. The largest individual contribution to the limiting resistance of the cell is actually made by the charge transfer reaction at triple phase boundaries (TFB) in the fuel electrode. In the TPB, the electron-conducting and electrocatalytically active Ni, the gas-conducting pore, and the oxide-ion-conducting YSZ are adjacent to each other.

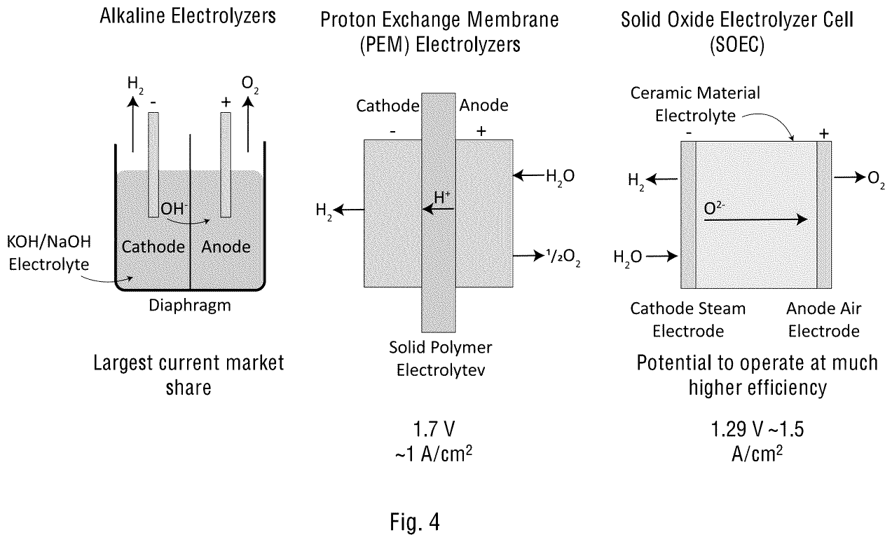

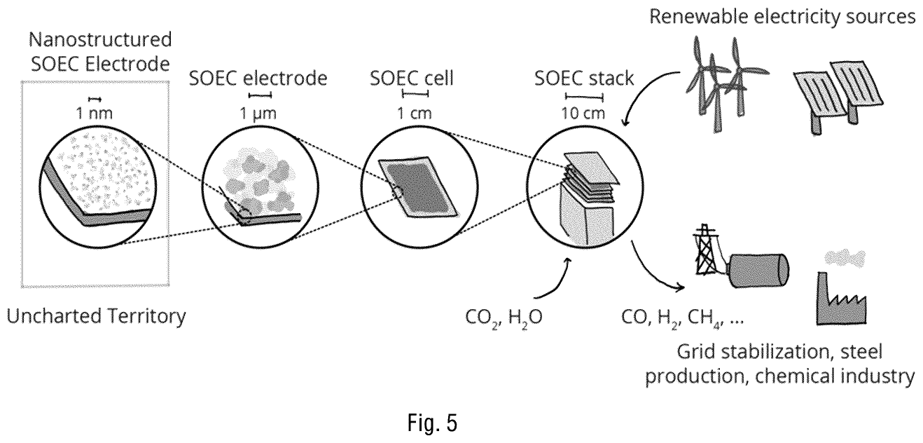

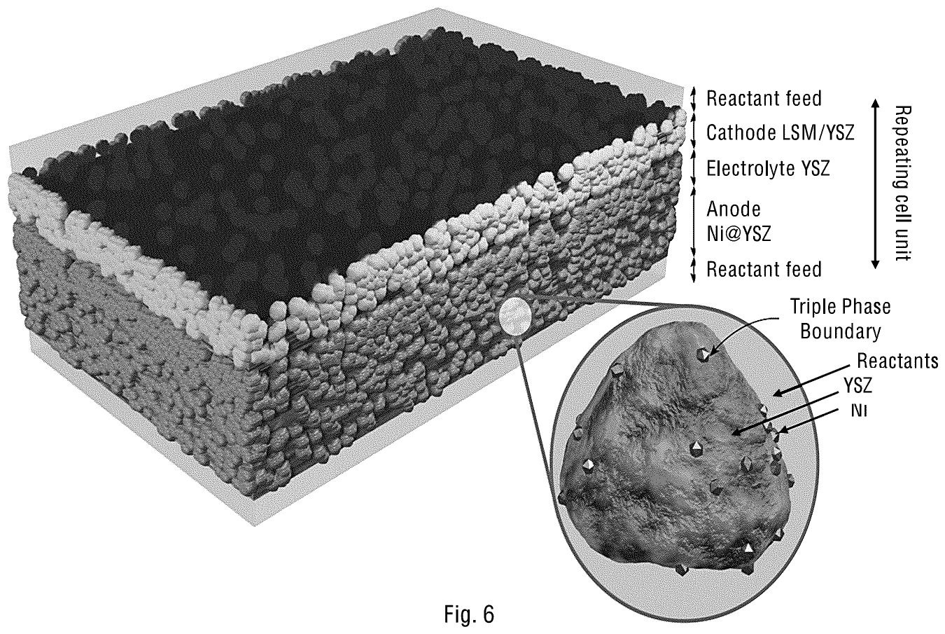

Reference is now made to FIG. 4 schematically showing available electrolysers. Solid oxide electrolysers allow operation at much higher temperatures (800-1000° C.) than conventional electrolysers due to the presence of the solid-state electrolyte which requires much less overvoltage and higher maximum current densities. FIG. 5 schematically shows the various relevance scales associated with solid oxide electrolysers and their inclusion in a renewable energy storage scenario. In addition, FIG. 6 schematically shows a repeating cell unit of a solid oxide electrolyser cell, prepared by wet chemistry methods.

The concept of a three-phase boundary shown in FIG. 6 is especially important when describing electrodes in fuel cells and batteries. For example, for fuel cells, the three phases are an ionic conductor (electrolyte), an electronic conductor, and a virtual “porosity” phase for transporting gaseous or liquid fuel molecules. The electrochemical reactions that fuel cells use to generate electricity take place in the presence of these three phases. Thus, triple phase boundaries are electrochemically active sites on the electrodes. The oxygen reduction reaction occurring at the cathode of a solid oxide fuel cell (SOFC) can be written as follows:

O₂(gas)+4e⁻(electrode)→2O₂⁻(electrolyte)

Some advances in imaging techniques have made it possible to study the three-dimensional distribution of TPB in real electrodes, which has already led to some improvements in electrode performance. New material processing techniques, for example, have made it possible to reduce the thickness of the Ni-YSZ composite support layers from the usual 0.5-1.0 mm to approximately 0.3-0.6 mm. While these improvements are commendable, there is still a long way to go to get sufficiently efficient SOECs for large-scale applications.

New techniques such as spark ablation are a viable option for strategic nanostructures and could further reduce thickness. There is strong evidence that YSZ nanostructured electrodes will provide impressive efficiency gains, for example by reducing TPB resistance. However, the current state of art devoted to this effect, uses expensive methods (for example, ALD), which cannot be used in the production of electrodes on an industrial scale due to their slow growth rates.

Unfortunately, as mentioned above, the conversion of CO₂ and/or H₂O in SOECs is an electrocatalytically coupled reaction for which very little progress has been made in understanding its working under operating electrochemical conditions. Reported co-production rates for the electrochemical conversion of CO₂ and H₂O are at least two orders of magnitude lower than those required for industrial applications. Much-needed improvements are required to help deal with the huge impact that fossil fuel use has on the environment, such as H₂ production.

One of the reasons that so much is still unknown about spark ablation is that the study of processes on the surface of electrodes under appropriate conditions, especially in nanostructured electrodes, is inherently difficult. Many different things happen at the same time during a reaction, the active particles can be hidden from view, and the electrolyte layer can hide many important details (if light can penetrate it at all). In addition, a common problem in catalysis studies, and especially electrocatalysis, is that much of the data presented was obtained under different and inconsistent conditions, making comparisons difficult and therefore drawing conclusions over a wide range of data. To design optimal electrodes, many different variables must be considered, such as catalyst layer thickness, particle spacing, metal (oxide) nanoparticle size, composite (such as YSZ) particle size, and various weight loads. Ideally, they should be tested under the same conditions to understand the overall impact of one on the other.

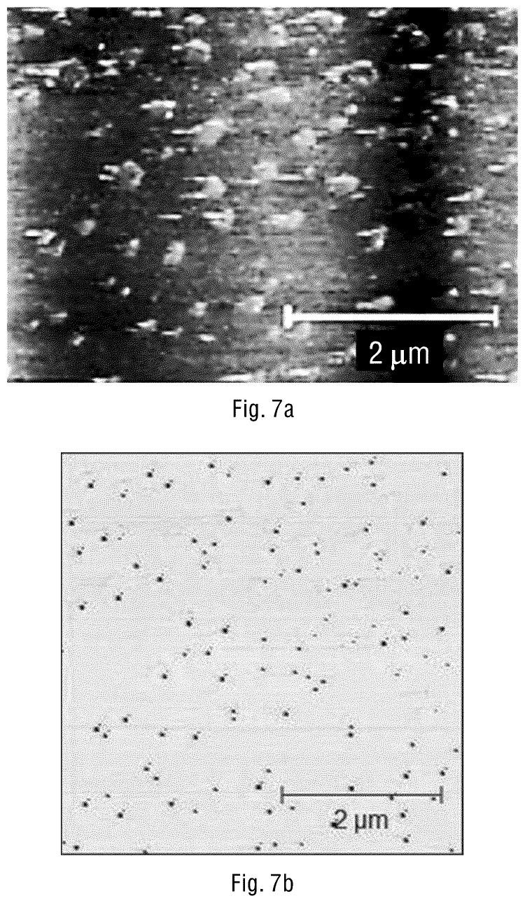

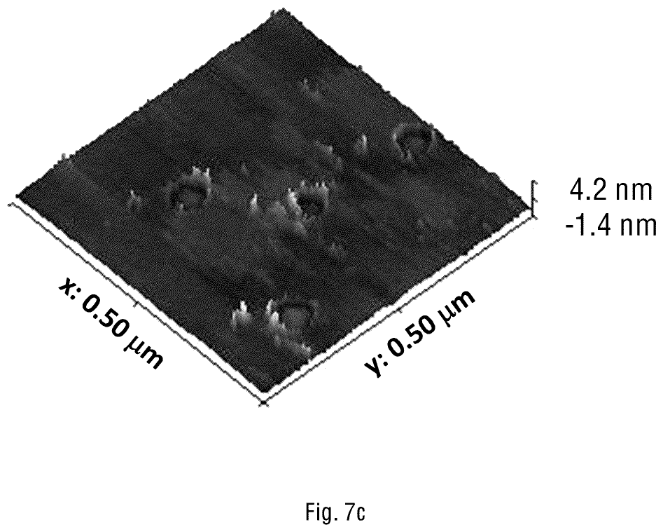

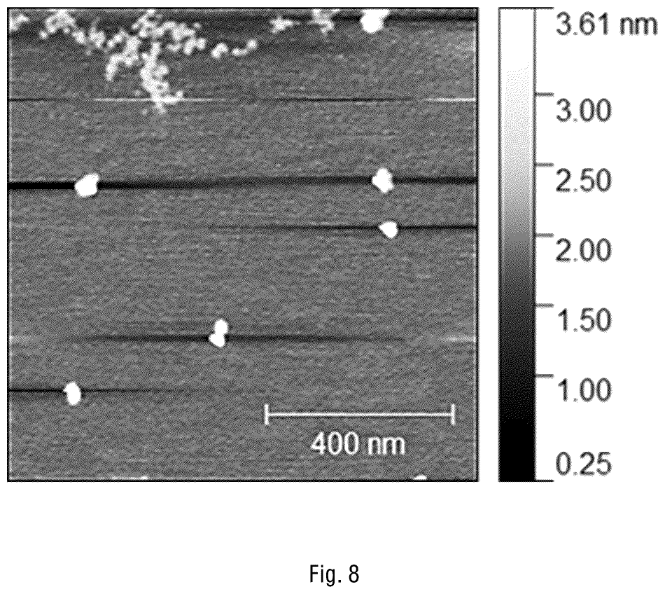

Reference is now made to FIGS. 7a-7c and 8 demonstrating impaction at Mach speed that creates “craters” upon impact during the spark ablation process. The craters are clearly visible in these figures as large halos around the nanoparticles. A Cypher ES Environmental AFM was used to record the images in FIGS. 7a-7c and 8 in air tapping mode (AC mode), at room temperature, using also the blueDrive™ laser and 256 points per image, 30 nm sample roughness. The tips were 240AC-NG, with a length of 240 micrometres, a width of 40 micrometres and a frequency of 70 kHz. FIG. 7a shows the recorded AFM image of a typical deposition of copper nanoparticles (9 nm) on a mica sheet. The larger “craters” on the surface of the mica are caused by the impaction of the nanoparticles over the mica. FIG. 7b shows the recorded AFM image of the same sample displaying the phase detector channel, where the black spots indicate a different material between the support and the nanoparticles. FIG. 7c shows the topography AFM image showing the profile of the “craters” created upon impact to the mica. FIG. 8 shows the AFM image of the deposition of platinum (Pt) nanoparticles (>10 nm) on a mica sheet showing the monodispersity in the height (±0.1 nm) of the nanoparticles, and low aspect ratio, in the height profile created using high-sheath flow and high-speed impaction. Indeed, looking at FIG. 8, it is clearly visible that the shape of the nanoparticles looks like “smooshed”, so the diameter or the base of the nanoparticles is much larger than the height. The craters in this AFM image are much less visible because a slightly more rigid support was used.

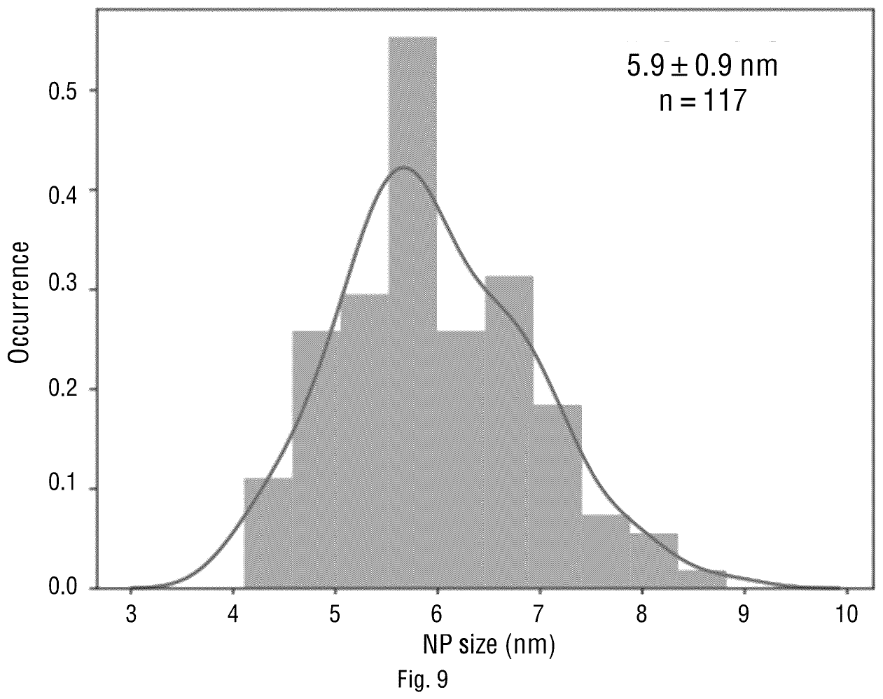

FIG. 9 shows the histogram of 117 counted Cu nanoparticle sizes by TEM analysis for a deposition with low sheath flow, for nanoparticles with a mean diameter of 5.9±0.9 nm. This figure clearly supports that the standard deviation is tuneable. Indeed, by changing the sheath flow, the standard deviation of the nanoparticles can be tuned below 1 nm.

Preparation of the materials of the present invention is described in the Examples section of the description. After preparing the materials as described in the subsection above, the materials were characterized for their electrochemical characteristics and physicochemical properties by comparing the nanostructured electrode (NS) material of the present invention with an electrode created by deposition of a catalyst ink, a catalyst consisting of 5 wt % Ni on YSZ prepared by incipient wetness impregnation (IWI).

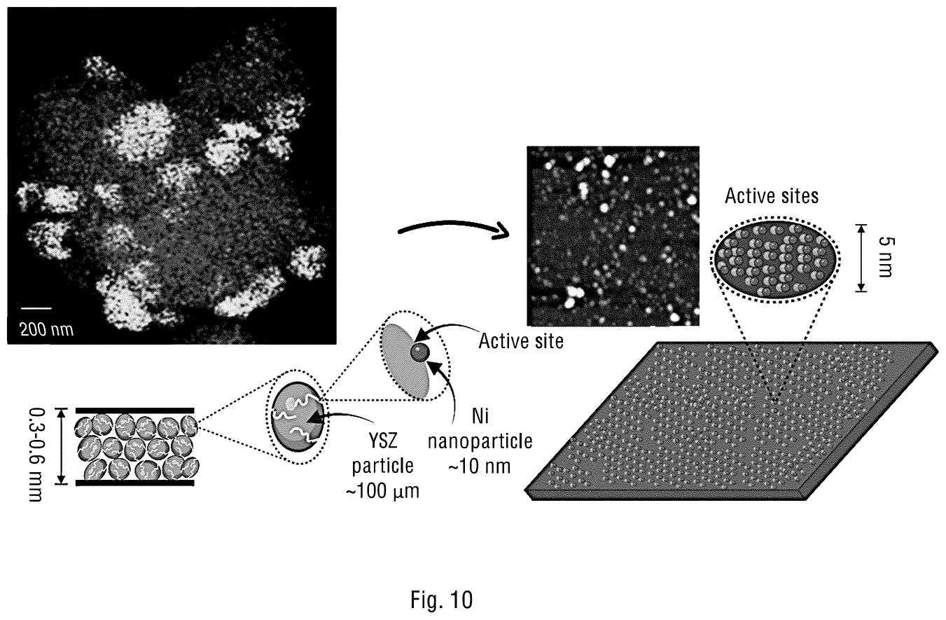

Reference is now made to FIG. 10 showing a general view of the two electrodes compared to each other. On the left is the IWI electrode, where the YSZ particles are on the order of a micron, with a porous structure on which Ni nanoparticles can be observed in the TEM-EDX image showing Zr and Ni. On the right, the small-scale topography of the NS electrode of the present invention measured by atomic force microscopy (AFM), because the tiny nanoparticles could not be well characterized by SEM (too small), and the electrode was prepared on glassy carbon (which was too thick to be transparent for TEM).

### Preparation of a Nanostructured Ni@YSZ Electrode by Spark Ablation

Preparation of NS Ni@YSZ was done using spark ablation, by use of a VSParticle G1 generator and Si size selector. All elements (i.e., Zr, Y, and Ni) were deposited separately on top of a 4×4 mm glassy carbon square with 1 mm thickness. Deposition was performed at the maximum distance between the deposition stage and the size selector nozzle (3 mm in this case), which allowed an overall surface deposition diameter of ˜3.5 mm. Zr was the first layer deposited, using spark power of 10 W (Voltage 1.3 kV, Current 7.7 mA), argon flow of 15 L/min and a selected particle size diameter of 10 nm.

Deposition was halted once the accumulated charge reached ˜200 nC which correlates to full surface coverage of Zr on the electrode. The second deposited layer of Y took place with operational parameters of 10 W (Voltage 1.3 kV, Current 7.7 mA), argon flow of 15 L/min, and a selected particle size diameter of 10 nm. The accumulated charge of Y deposited was ˜12 nC, which corresponds to a surface coverage by weight of 5% from the total Zr weight deposited in previous layer. The Ni layer was deposited last, with operational parameters of 3 W (Voltage 1.3 kV, Current 2.3 A), flow of 15 L/min, and selected particle diameter of 7 nm. As the surface coverage of Ni was intended to reach 5% from the overall weight of both Zr and Y, the accumulated charge of Ni was set to ˜20.5 nC.

### Preparation of 5% Ni@YSZ by Incipient Wetness Impregnation (Industry Standard, IWI Ni@YSZ)

2 g of YSZ (5% weight of Y) powder was placed in a two neck round bottom flask. The flask, with its YSZ powder content, was connected to a vacuum pump through one outlet and was sealed with a septum to the other. The YSZ powder was then heated to an approximately 60° C., while stirring, under vacuum conditions for 0.5-1 h for removal of water the YSZ pores. After the drying process, a 2.5 mg/mL nickel nitrate solution (Ni(NO₃)₂6H₂O 99.99% purity, Sigma Aldrich) in water was added to the dried YSZ powder, using a syringe to inject through the flask's septum. In incipient wetness impregnation, the pore volume of the dehydrated powder is intended to be replaced with the exact same volume of Ni salt solution. As the pore volume of YSZ powder was measured to be 0.031 cm3/g (characterised using nitrogen physisorption), and the overall mass of YSZ in the flask was 2 g, the volume of the Ni solution prepared was 0.062 mL.

Optimally, the concentration of the Ni solution is chosen such way that within the added volume used, the Ni amount is correlated to the intended final product's weight-percentage of Ni. As nickel nitrate has solvability limitations under the specific parameters set for this study (i.e., volume, Ni weight-percentage), the concentration used (2.5 mg/mL) was chosen as it contains (in a 0.062 mL) Ni amount that correlates to 2.5% weight of the 2 mg YSZ. As such after the first injection, the mixture was left to dry in a fume hood overnight, and another injection of the nickel nitrate solution was performed, using the same conditions as described above. After two rounds of Ni nitrate to the YSZ, the obtained powder was reduced with forming gas (a mixture of 5% H₂ in Ar, 100 mL/min), using a temperature increase of 5° C./min from room temperature to 450° C., and kept at 450° C. for two h. This powder was characterised using a number of characterisation procedures described in the present specification.

### Activity Measurements of the Ni@YSZ Electrodes in the SOECs

First, the activity of the NS electrode produced by the method of spark ablation was set in comparison with the IWI electrode. For this, several electrochemical methods have been applied, including chronoamperometry and cyclic voltammetry. Although the electrochemical measurements shown here were performed in the liquid phase and at room temperature, the resulting difference in activity can be directly extrapolated to high temperature SOEC applications.

Reference is now made to FIG. 11 showing the current densities in a chronoamperometric measurement of each electrode over several hours. Chronoamperometry measures current over time at a constant voltage. Current density (measured current corrected for electrochemically active surface area) can be taken as a direct measure of H₂ production activity. FIG. 11 clearly shows that the NS electrode of the present invention achieves an improvement in current density by almost two orders of magnitude compared to the IWI electrode. For both catalysts, a decrease in time is observed, which is very likely due to the instability of nickel in the liquid phase. Tests at high temperature and with liquid gas are likely to show much higher stability.

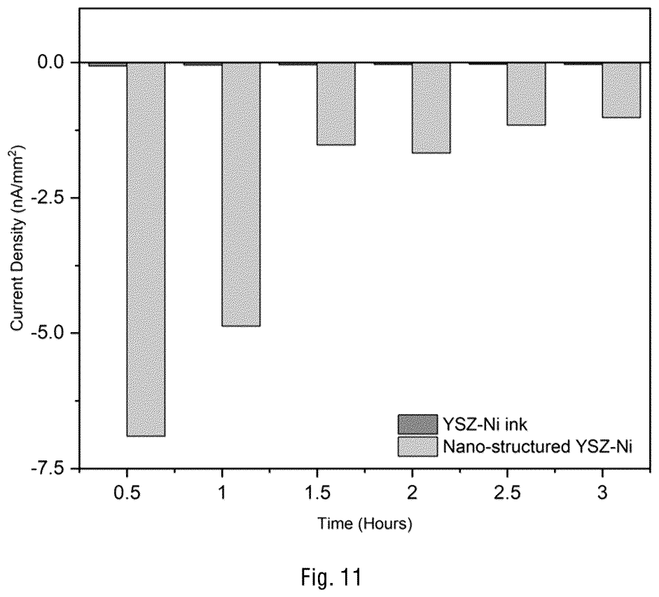

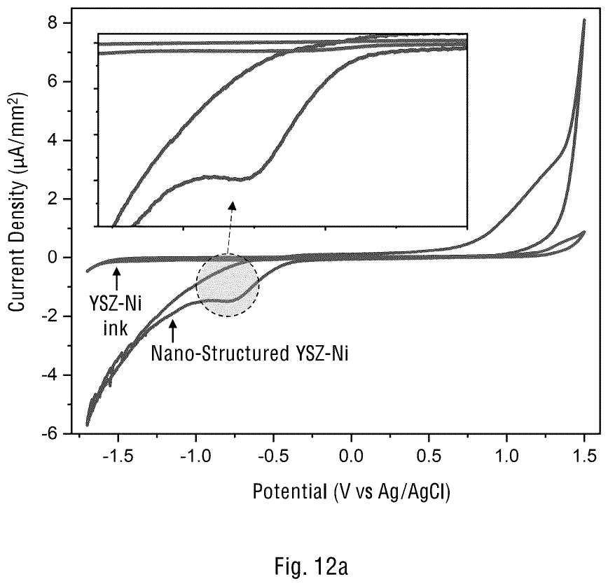

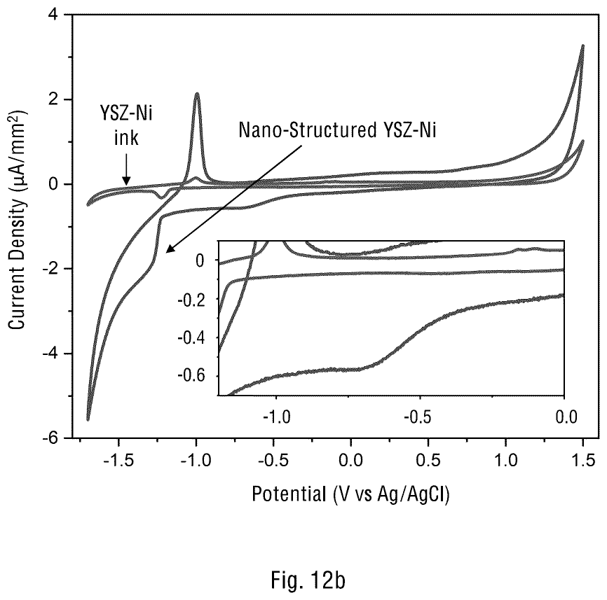

FIGS. 12a-12b show cyclic voltammograms of the IWI electrode (red) and the nano-structured electrode of the present invention (blue). FIG. 12a shows the comparative electrochemical activity of both IWI and NS electrodes in a pure H₂ production mode (water splitting only, water is converted to hydrogen) and FIG. 12b shows the comparative electrochemical activity of both IWI and NS electrodes in an operating combined supply mode, in which CO₂ is co-fed with water (both are converted). Cyclic voltammetry is a method of electrochemical characterisation that makes it possible to study both the onset potential and the current density of the studied electrochemical reactions. It is also clear from this characterization procedure that the current density of the present electrochemical reactions is much higher for the nanostructured electrode of the present invention.

In addition, from the graphs in FIG. 12, it can be deduced that the hydrogen evolution reaction (HER, 2H⁺+2e⁻→H₂) starts at about −0.7 V relative to Ag/AgCl when operating in pure HER mode. With co-feeding of CO₂, the apparent HER reduction peak at −0.7 V vs. Ag/AgCl is maintained, but another catalytic wave at −1.2 V vs. Ag/AgCl can be observed. In addition, an oxidation peak of about −1.0 V relative to Ag/AgCl can be seen. The full-length width Y (current density) of the NS electrode of the present invention suggests that the CO₂ reduction reaction starts quite close to 0 V, at about −0.2 V relative to Ag/AgCl.

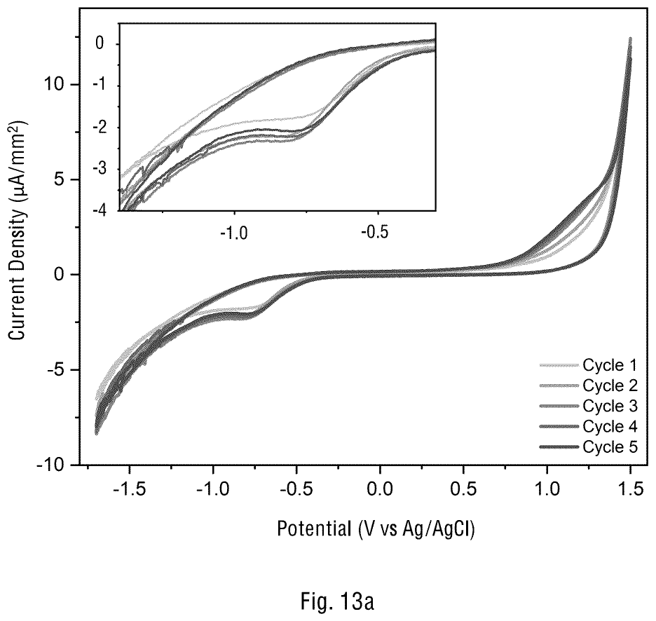

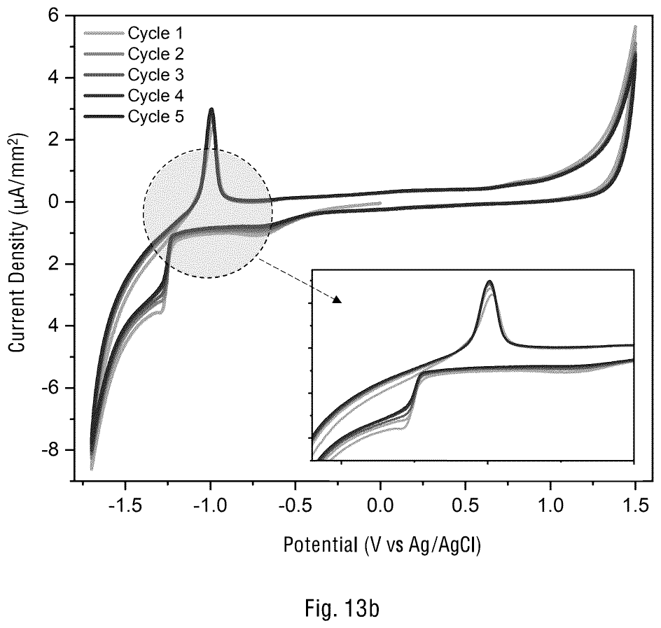

FIGS. 13a-13b show cyclic voltammetry measurements made over several cycles, a technique that can be used to determine the (preliminary) stability of an electrode under reaction conditions. The figures clearly show that there is a slight decrease in current density over successive cycles for the CO₂ combined reaction in FIG. 13b, but an increase in current density over time for the pure hydrogen method in FIG. 13a. These preliminary stability tests help confirm what was also observed in FIG. 11, and as mentioned above, catalyst stability is likely to improve significantly at higher temperatures due to the formation of nickel hydride in aqueous electrolyte solutions.

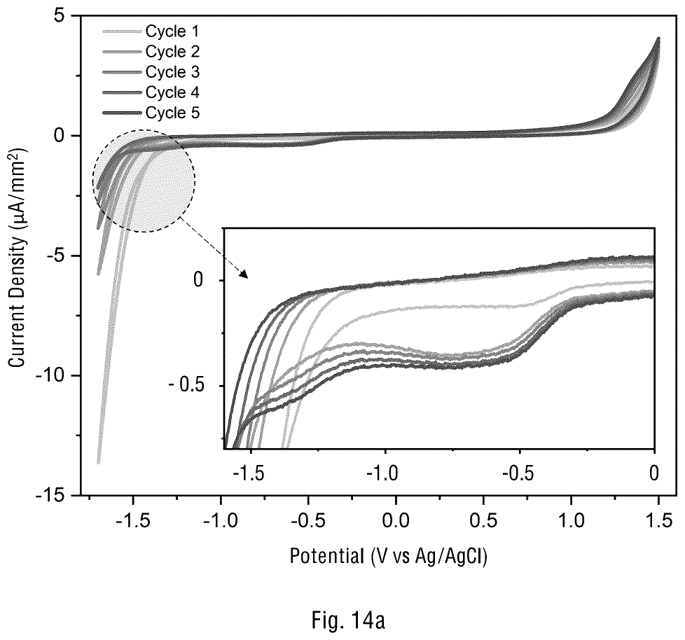

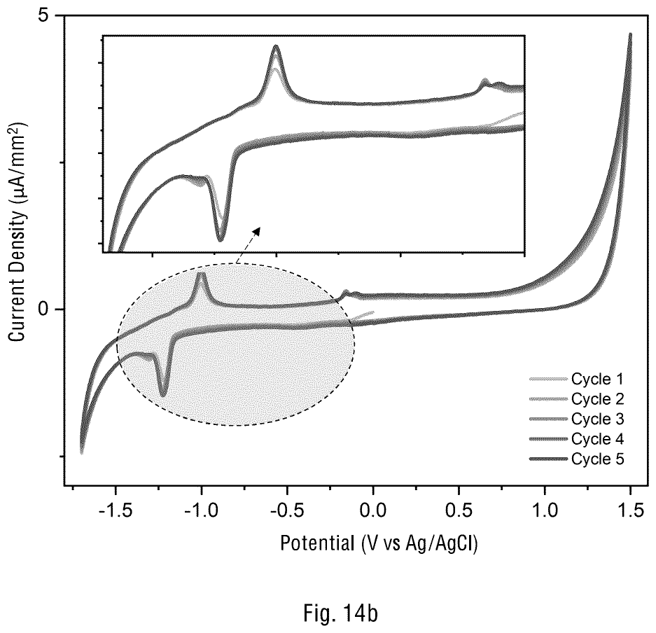

FIGS. 14a-14b show cyclic voltammetry measurements conducted over several cycles on an IWI electrode fed only with H₂O to produce H₂ (FIG. 14a) and CO₂ co-fed with H₂O (FIG. 14b). Similar trends can be observed in both cases.

### Physicochemical Characterisation of the Nanostructured Ni@YSZ Electrode

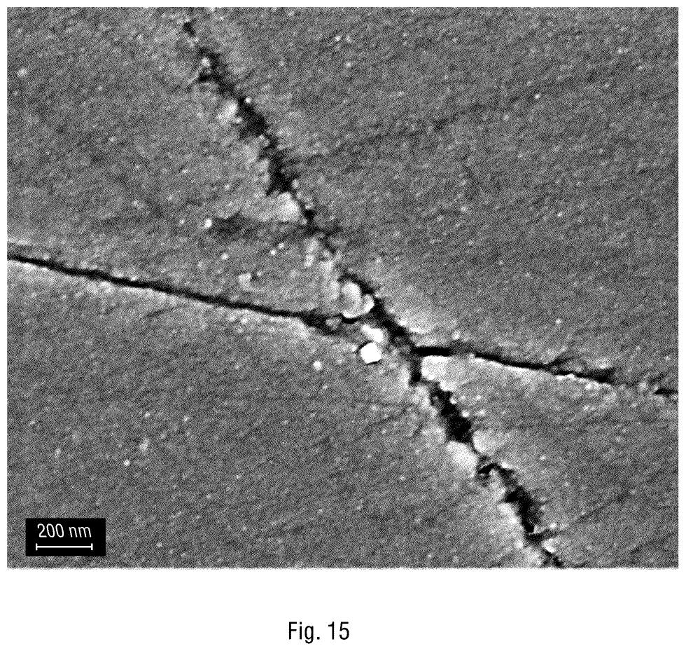

Many different analytical methods have been used to fully characterise various electrode materials. In general, since the NS electrode of the present invention contain nanoparticles smaller than 20 nm, scanning electron microscopy is not suitable for physicochemical characterisation of this electrode. Reference is now made to FIG. 15 shows a high-resolution SEM micrograph taken with a Zeiss Ultra-Plus HR-SEM showing small brighter dots on the glassy carbon surface. It can be seen from these micrographs that the nanoparticles deposited by spark ablation, causing a sharp increase in activity, are small.

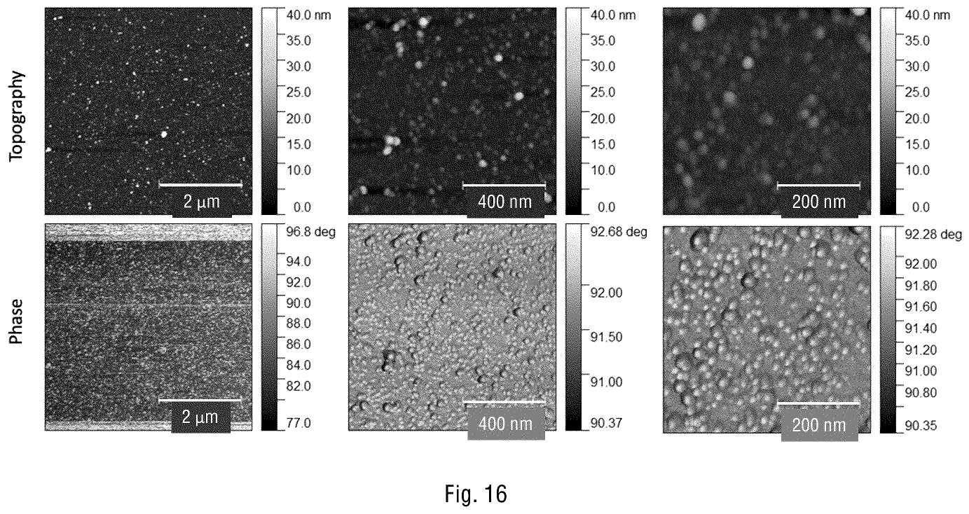

FIG. 16 shows various scales of the NS electrode topography, as well as phase-channel images obtained using atomic force microscopy (AFM). Complete coverage of the Zr surface was ensured, and Yr and Ni in small amounts (relative to the amounts found in the IWI electrode) were subsequently deposited and detected.

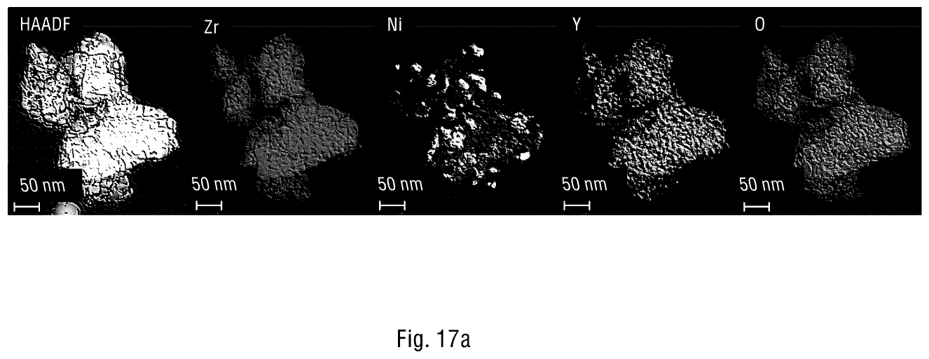

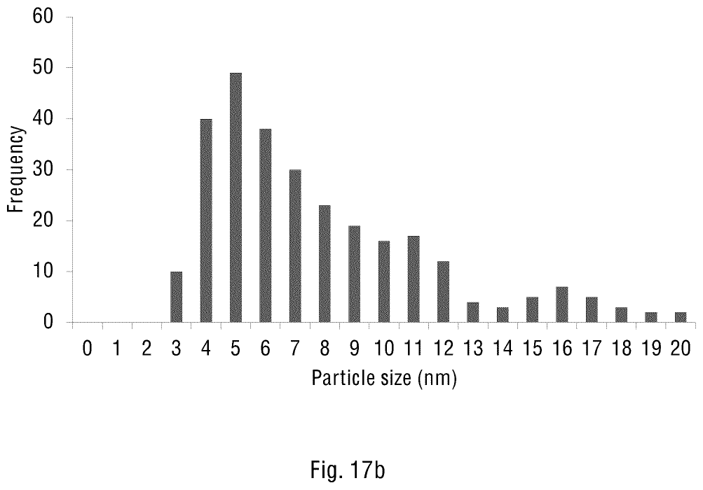

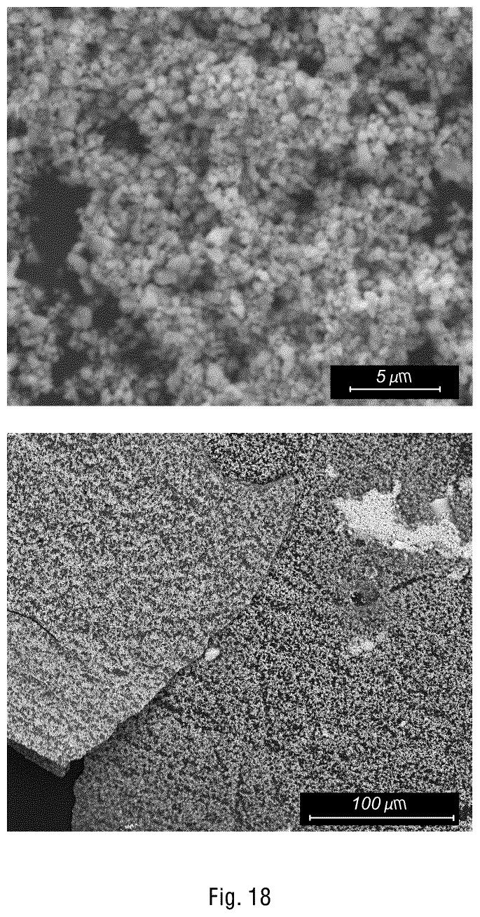

FIG. 17a shows the images of the 5 wt % Ni-YSZ powder, which was used in the preparation of the IWI electrode. These images are made with the transmission electron microscopy-electron diffraction X-rays (TEM-EDX). FIG. 17b shows the granulometry analysis in the histogram of the Ni particle size distribution. The average particle size measured is 8.6 nm, the median particle size is 6.7 nm. FIG. 18 shows the high-resolution scanning electron microscopy (HR-SEM) images of the 5 wt % Ni-YSZ powder used to prepare the IWI electrode.

Thus, in one aspect, the present invention relates to the production of cathodes and anodes based on yttrium-stabilised zirconium oxide for solid oxide electrolysers and solid oxide fuel cells. Nanoparticles created by spark ablation are less than 100 nm, and in the present invention they are less than 20 nm, often even less than 10 nm. By nano structuring the yttrium-stabilised zirconium material together with nickel, a significant improvement in current density by about two orders of magnitude was achieved.

The method of the present invention focuses on nano structuring the YSZ component, which is mandatory, and for which nano structuring efforts are unknown. In contrast, other methods, such as atomic layer deposition focus on nano structuring a single metal component, nickel, for instance. There are three main limitations of ALD: the extreme slowness of the process, the limited choice of materials and processes, and the inability to accurately control 3D geometry. The ALD method cannot be applied on the industrial scale required for the production of electrodes and has shown only marginal improvements.

In one aspect of the present invention, a method for manufacturing of a nanostructured electrode, said nanostructured electrode comprises a conductive electrode support coated with yttria stabilized zirconia (YSZ), said method comprises depositing nanoparticles of zirconia, yttria, and nickel on said conductive electrode support using the method of spark ablation. In a specific embodiment, the percent ratio of the materials in the produced composite nanoparticles are: zirconia (±82%), yttria (±8%), and nickel (±10%).

The novelty of the method of the present invention compared to existing methods is based on the nanoengineering of the electrode for solid oxide electrolysis cells (SOECs) using spark ablation, which makes it possible to create very small particles of conductive ionic materials. Non-limiting examples of these materials are yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel. Exemplary embodiments are very small particles of zirconia (about 20 nm and less), very small yttrium particles (about 20 nm and less) and very small nickel particles (about 20 nm and less). All of these components are needed at the same point (three-phase boundary) for an efficient reaction. But typically, especially yttrium-stabilized zirconia, is hundreds of microns in size, severely limiting activity. This method of making electrodes is very simple, cheap, and scalable, and has proven to be very valuable for many different methods of manufacturing electrodes.

The method of spark ablation for generating nanoparticles used in the present invention comprises generating sparks between two electrodes of a spark ablation device by repetitively providing pulsed energy to these electrodes, and by providing gas to an inlet/outlet of the spark ablation device, wherein said two electrodes are hollow and connected to a gas supply, wherein a continuous discharge or simmer discharge is maintained between these electrodes at a first energy level derived from a continuous DC or AC power source, and supplementing pulsed power from the same or another power source, for repetitively varying power output between a first energy level and a second energy level to arrange that a continuous discharge is maintained between the electrodes of the spark ablation device at the first energy level, and wherein the energy level of the discharge is intermittently increased from said first energy level to a second energy level higher than the first energy level for ablating at least a portion of the electrodes, wherein the first energy level is selected at a level insufficient to generate nanoparticles, and the second energy level is selected at a level to unavoidably generate nanoparticles, and providing the generated nanoparticles to an outlet of the spark ablation device, wherein the generated nanoparticles are removed via one or both of the electrodes and wherein the energy of the discharge is intermittently increased by providing electrical pulses to the electrodes.

The electrodes of the spark ablation device are subjected to a magnetic field for maintaining uniform ablation of the electrodes of the spark ablation device. Thus, nanoparticles of zirconia, yttria, and nickel were deposited on a standard conductive electrode support (e.g., glassy carbon) by spark ablation (using a spark ablation device). This YSZ composite mimics the material currently used in solid oxide electrolysis cells (SOECs) in terms of composition. The nano structed engineering method makes it possible to create of a three-phase boundary (TPB) that was not possible before, especially in a method that can be infinitely upscaled.

In a further embodiment, the nanostructured electrode of the present invention is used in the following applications, which will be briefly described below:
(1) Descaling of water.
(2) Electrochemical desalination of water.
(3) Selectively increasing the pH of water.

### Applications and Examples

Water, especially sea and brackish water, contains many different elements. Approximately 2.5-3.5% of sea water consists of salts (about 600 mM), mainly sodium and chloride. Sulphates make up approximately 7.7% of the total salts contained in sea water, magnesium—3.7%, calcium—approximately 1.2%, potassium—1.1%, and other minor components make up the rest. The abundance of (sea) water on the planet and the many different ways in which it is used lead to a number of different problems and opportunities associated with these dissolved salts in (sea) water, three of which are highlighted below.

### Pre-Treatment for Water Desalination

Scale deposits can easily form on flow surfaces when the solution concentration is above the solubility limit of a dissolved sparingly soluble salt or when a solution containing a salt with inverse solubility contacts a hot surface. Such conditions are met both in thermal and membrane desalination processes. The deposition of scale is unacceptable due to the extremely detrimental effect on production capacity and specific energy costs. A typical scale-control method used in desalination is based on the dosage of inhibitory compounds that can suppress scale formation to a certain extent. The maximum level of water recovery that can be achieved in brackish water desalination is determined by the ability of the descaling agents to suppress scale formation.

### Descaling of Water

The deposition and formation of scale is a problem that can be encountered in places where large volumes of water flows are used for various end purposes. For example, in cooling towers or housing estates in areas with a relatively high concentration of salts in drinking water. This scale build-up can be so severe that it can affect the structural integrity of buildings or reactors, or simply affect the taste and texture of residential drinking water.

### Electrochemical Precipitation

It is clear from what is described above that the ability to control salt deposition in (sea)water can be very useful. Electrochemical descaling has many advantages: environmental friendliness, no need for handling and dosing of reagents, automation and convenient process control.

As discussed above, the solubility of carbon dioxide in seawater is pH dependent: the higher the pH, the more CO₂ can be dissolved in seawater. In addition, there is a negative correlation between CaCO₃ solubility and pH. Or, in other words, the higher the pH, the more CaCO₃ will precipitate. Although this is a problem for the ocean alkalinity enhancement (OAE) methodology described above, since uncontrolled CaCO₃ precipitation removes more alkali than is added by dissolving quicklime, electrochemical precipitation can exploit this effect.

Calcium carbonate electrochemical precipitation can be used as a water pre-treatment method, for example, before membrane desalination or for descaling. By splitting water and thus, increasing the pH locally around the electrode, precipitation of CaCO₃ is induced, as indicated in the following chemical equations:

O₂+2H₂O+4e⁻→OH⁻2H₂O+2e⁻→H₂+2OH⁻Ca²⁺+HCO₃⁻+OH⁻→CaCO₃+H₂O

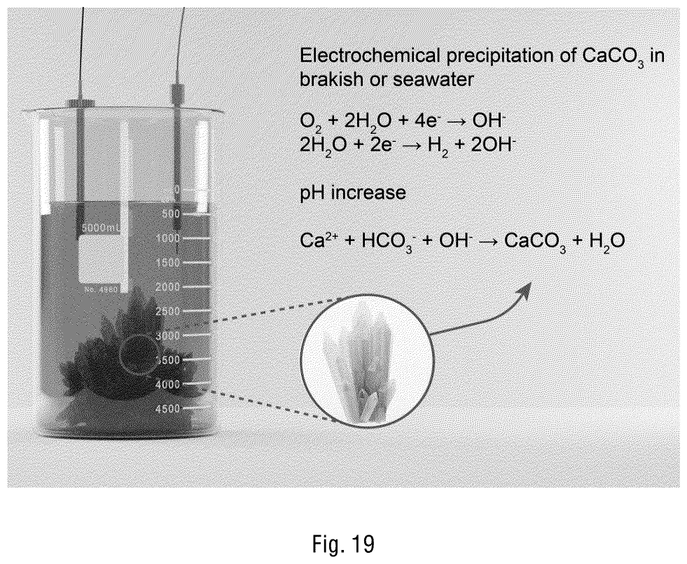

FIG. 19 schematically represents the idea of electrochemical deposition, if it were carried out in the schematically depicted manner, then the main factor preventing its use would be that calcium carbonate is deposited on the working electrode, which requires a very high specific area of the electrode. In addition, precipitates must be periodically removed, and the accumulation of the precipitates on the cathode is associated with many other additional disadvantages. The nominal precipitation rate for this method is about 50 g CaCO₃/h/m².

The main barriers to applying the aforementioned electrochemical precipitation includes the CaCO₃ deposition on electrodes, requirement for large electrode surface area (capital cost) and for high overvoltage (maintenance costs).

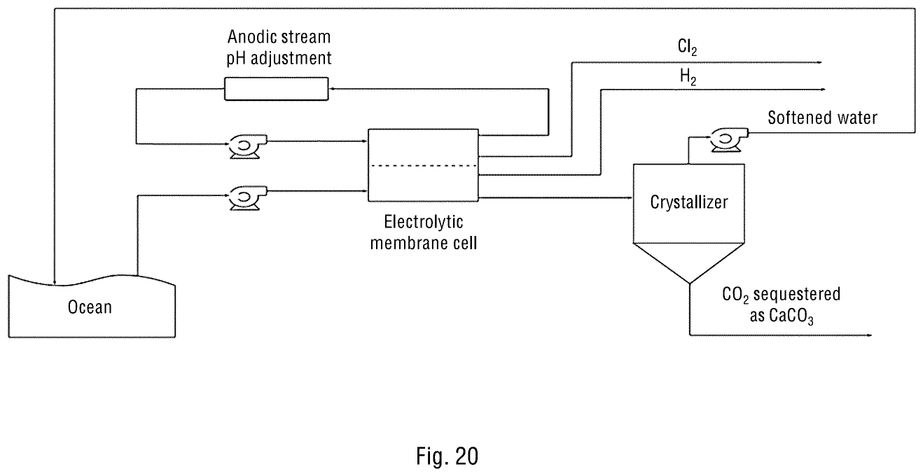

Reference is now made to FIG. 20 showing the scheme of the electrochemical deposition process with a calcium carbonate seed system. Sea water is pumped through an electrochemical precipitation cell, in which the cathode and anode compartments are separated. By creating a higher pH in the cathode chamber due to the water splitting reactions described above and feeding this alkaline stream into the crystalliser where CaCO₃ seeds are present, the CaCO₃ in the sea water is precipitated. Depending on the desired application, either this pre-treated water is used further, for example for membrane-based water desalination, or the descaled water can be used directly, for example in cooling towers. Alternatively, in a carbon sequestration scenario, the alkaline feedstock could either be returned directly to the seawater, or calcium levels could be raised again by adding quicklime before the stream is released back into the ocean, where it captures more carbon dioxide.

Of course, it follows from the above explanation that the use of electrochemical precipitation of CaCO₃ as a pre-treatment for water desalination captures CO₂. Integration and optimisation of this process, for example, with Israeli desalination plants, could mean that two birds are killed with one stone. That is, water is pre-treated for desalination and CO₂ is captured from the air and sequestered simultaneously. Precipitated calcium carbonate should be used or stored in such a way that it cannot be released back into the air. That is, it cannot be used for the production of cement, where CO₂ is released again.

The following stream table shows calculating the amount of seawater, which is required to capture 1 kiloton/year of CO₂ via electrochemical CaCO₃ precipitation:

EPS Stream Table

| | | | Cathodic | Anodic | CaCO₃ | |
|---|---|---|---|---|---|---|
| | Sea water 1 | Sea water 2 | stream | stream | stream | Soft water |
| Mass Flow [ton/year] | 9995852 | 9995852 | 9995852 | 9995852 | 4127 * | 9991725 |
| Inorganic Carbon | 0.0276 | 0.0495 | 0.0495 | — | — | 0 ** |
| Composition [g/kg] | | | | | | |
| CO₂ sequestered | — | — | — | — | — | — |
| [ton/year] | | | | | | |
| Temperature [° C.] | 25 | 25 | 25 | — | 25 | — |

* Production per year.
** Assuming max. presipitation.

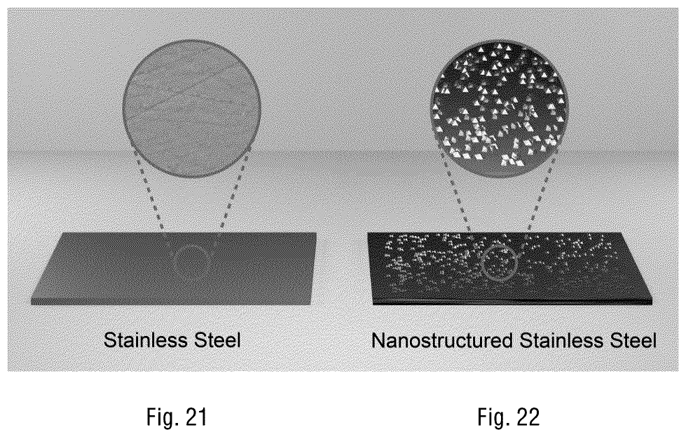

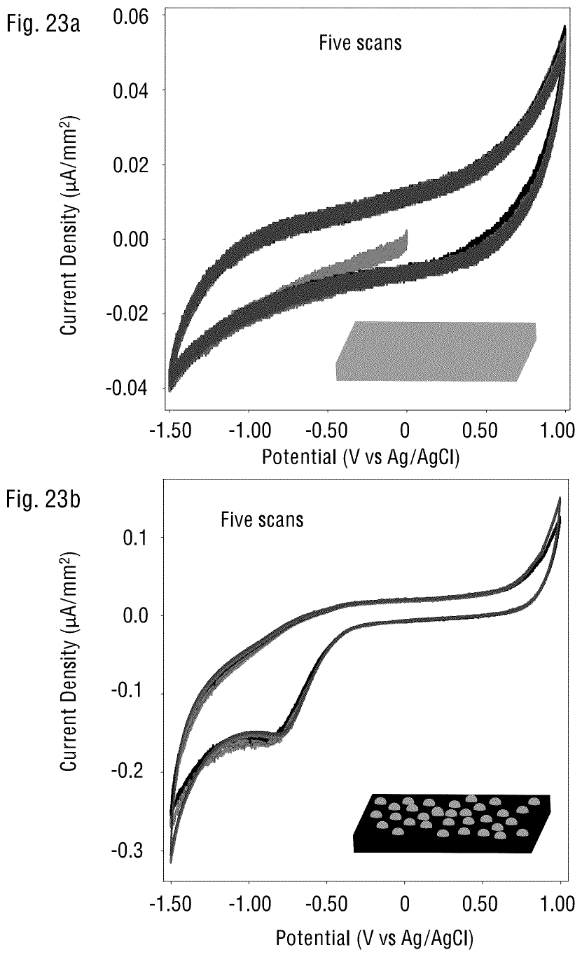

As large amounts of water should be processed via electrochemical precipitation, highly active electrodes must be used in order to achieve low operational costs (electricity costs). Electrochemical precipitation can be achieved with known, highly active electrodes such as Pt or stainless steel. FIG. 21 shows the stainless-steel material and the nanostructured stainless-steel material produced by the spark ablation technique for the creation of a conventional stainless-steel electrode. FIG. 23a shows cyclic voltammograms of a conventional stainless-steel electrode in the electrochemical precipitation of CaCO₃ in synthetic seawater.

High current densities of hundreds of mA/mm² are obtained for the electrochemical precipitation of CaCO₃ in synthetic seawater using Pt as electrodes. Such activities are highly desirable, and perhaps even necessary, in order for electrochemical precipitation as pre-treatment for desalination of water to be economically viable, thereby facilitating the viability of carbon capture. Nevertheless, the obvious downside of the use of Pt, and other typically used highly active electrodes is their extremely high cost. For this reason, stainless steel has been the preferred electrode material of choice for electrochemical precipitation. The activity of stainless steel is however very low (as seen in FIG. 23a).

FIG. 22 schematically shows the nanostructured stainless-steel material produced by the spark ablation technique for the creation of a nanostructured electrode of the present invention. As described above, this electrode of the present invention has one application in electrochemically enhanced precipitation of minerals in (sea)water. By nano structuring this typical cathode material, stainless steel, using the spark ablation technology described above, the initial potential required for water splitting is reduced. This method of the present invention requires even less total energy to increase alkalinity and subsequent electrochemical precipitation of calcium carbonate. The benefits of this method are significant improvement in activity, less material required, less surface area required, less electrical power required, highly customisable. FIG. 23b shows cyclic voltammograms of this nanostructured stainless-steel electrode of the present invention in the electrochemical precipitation of CaCO₃ in synthetic seawater as will described below.

### Preparation of Synthetic Sea Water

Synthetic sea water was prepared according to the following method:
Fill volumetric flask with approximately 850 mL of demineralised water.
2.922 g of NaCl.
Add 0.881 g of CaCl₂·2H₂O.
Add 0.578 g of NaHCO₃.
Fill up volumetric flask to 1 L with demineralised water.

### Stainless-Steel Electrode

To offset measurements of the nanostructured stainless-steel electrode of the present invention, a typical stainless steel reference measurement was done. To this end, a 3×3 mm square was cut out of 304 Stainless Steel sheet which has the composition described in Table 2 below.

TABLE 2
Type 304 Stainless Steel Chemical Composition, %

| C | Si | Mn | P | S | Cr | Ni |
|---|---|---|---|---|---|---|
| 0.08 | 1.00 | 2.00 | 0.045 | 0.030 | 18.0-20.0 | 8.0-11.0 |

### Preparation of Nanostructured Stainless Steel 304 (NS-SS-304)

Preparation of NS-SS-304 was done using spark ablation, by use of the VSParticle generator (G1) and size selector (S1). All elements (i.e., Fe, Ni, and C) were deposited separately on top of a 4×4 mm glassy carbon square with 1 mm thickness. Deposition was performed at the maximum distance between the deposition stage and the size selector's nozzle, which allowed an overall surface deposition of ˜1.5 mm. Fe was the first layer deposited, using spark power of 6 W (Voltage, 1.3 kV, Current, 4.6 mA), argon flow of 6 L/min and a particle size of 9 nm in diameter. Deposition was halted once the accumulated charge reached ˜24.2 nC which correlates to a full coverage of the electrode. Second deposited layer of Ni took place under operational parameters of 3 W (Voltage, 1.3 kV, Current, 2.3 mA), argon flow of 10 L/min, and a particle size of 7 nm. The accumulated charge of Ni deposited was ˜3.4 nC, which corresponds to a 10.8% surface coverage. For the C layer, deposited lastly, operational parameters of 2 W (Voltage 1.3 kV, Current, 1.5 mA), flow of 15 L/min, and particle size of 3 were used. As the surface coverage of C was intended to reach 0.42%, the accumulated charge of Ni was set to ˜0.1 nC.

### Electrochemical Activity Measurements of the Nanostructured Stainless-Steel Electrodes

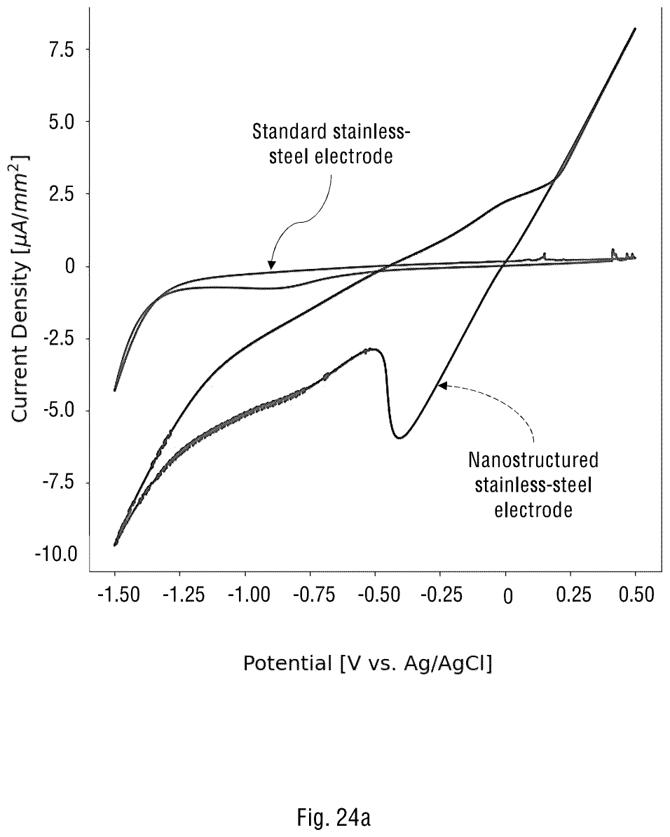

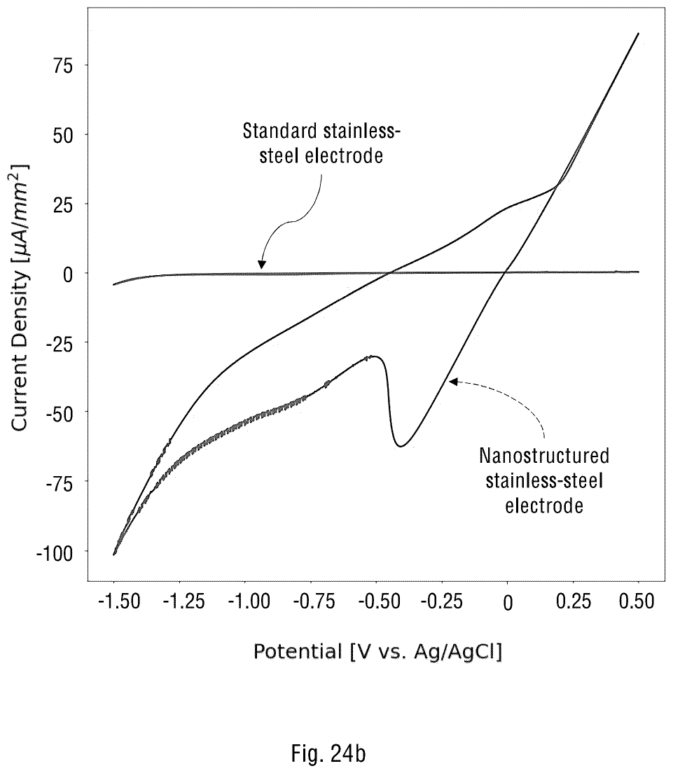

The nanostructured stainless-steel electrode prepared as described above was tested for electrochemical activity by electrochemical deposition of CaCO₃ in synthetic seawater. Reference is now made to FIGS. 23a and 23b showing cyclic voltammograms of a conventional stainless-steel electrode (FIG. 23a) and the new nanostructured electrode of the present invention (FIG. 23b), prepared by the method of spark ablation, respectively, in synthetic seawater containing a mixture of various salts including NaCl, MgO and CaOH. FIG. 24a shows the comparative cyclic voltammogram of a nanostructured stainless-steel electrode with 9.5% coverage versus the cyclic voltammogram of a conventional stainless-steel electrode in the electrochemical precipitation of CaCO₃ in synthetic seawater. FIG. 24b shows the comparative cyclic voltammogram of a nanostructured stainless-steel electrode with 9.5% coverage normalised to 100% coverage versus the cyclic voltammogram of a conventional stainless-steel electrode in the electrochemical precipitation of CaCO₃ in synthetic seawater.

There is a clear improvement in current density with the nanostructured electrode of the present invention, which is a direct indication of the rate of reaction at −0.8 V compared to Ag/AgCl. The current density for the conventional stainless-steel electrode at −0.8 V is −0.018 μA/mm², and for the nanostructured electrode of the present invention, the current density is −0.19 μA/mm² under the same conditions. This is an order of magnitude improvement.

However, it should be noted that the electrochemical current (activity) of the electrodes is normalised to the area of the electrochemically active surface, equal to 3 mm². In the case of a nanostructured electrode, the conductive electrode support, which is glassy carbon in the present example, was coated with a composition imitating stainless steel, inactive with respect to the described reactions. Thus, when the surface is completely covered with nanostructured stainless steel, the current density will be much higher, and the amount of material for the manufacture of electrodes that will be required will be at least 100,000 times less.

### Physicochemical Characterisation of the NS Stainless-Steel Electrode of the Invention

The NS stainless-steel electrode of the present invention has been characterised as described above regarding the nanostructured Ni@YSZ electrode, and further information on the size and shape characteristics of the nanoparticles can be found here. The particle size on the nano-structured stainless-steel electrode of the present invention is less than 20 nm, so scanning electron microscopy (SEM) is not suitable for the physicochemical characterization of this NS electrode.

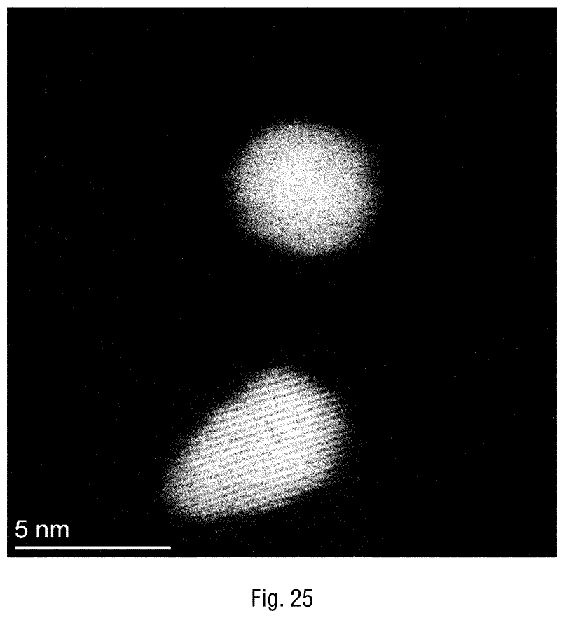

FIG. 25 shows a high-resolution transmission electron microscopy image of nanoparticles deposited by spark ablation onto a SiN membrane for detailed particle size and shape analysis. Size selection is combined with impaction at Mach speed, so it is impossible to deposit nanoparticles of the selected size on the TEM grid. The TEM image shows nanoparticles whose size was not selected and which were deposited by diffusion, in contrast to the nanoparticles that were deposited for the measurements shown in FIGS. 24a-24b. However, using the similar deposition parameters as for the nanostructured stainless-steel electrode described herein with diffusion parameters results in an average Gaussian nanoparticle size distribution in the nanoparticles aerosol created by the spark ablation of about 6 nm, which is clearly seen in FIG. 25.

### Preparation of Nanostructured Composite Materials by Spark Ablation

Preparation of nanostructured yttrium-stabilized zirconia, lanthanum strontium cobaltite, lanthanum strontium manganite, lanthanum strontium cobalt ferrite, was done using spark ablation, by use of a VSParticle G1 generator and S1 size selector.

Alloys of the material in the desired elemental composition of metals were used (i.e., Y_{0.03-0.15}Zr_{0.85-0.97}, La_{0.6-0.9}Sr_{0.4-0.1})_{0.8-1}Co₁₋₃, La_{0.6-0.99}Sr_{0.01-0.4}Mn, and La_{0.1-0.4}Sr_{0.6-0.9}Co_{0.2-0.8}Fe_{0.2-0.8}) were reacted in-stream with a small amount of oxygen (0.01-10% O₂ in inert), where the oxygen was introduced either at the point of ablation, or near the deposition point. The materials were made varying the reaction temperature from room temperature, to 100° C. at the point of the oxygen stream introduction. Deposition was performed at the maximum distance between the deposition stage and the size selector nozzle (3 mm in this case), which allowed an overall surface deposition diameter of ˜3.5 mm. Deposition was halted once the accumulated charge reached ˜400 nC which correlates to full surface coverage.

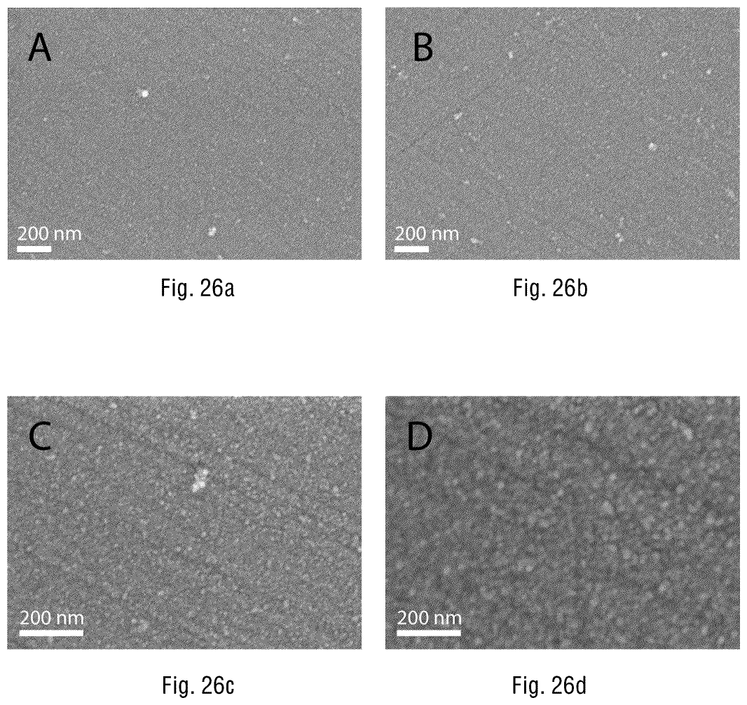

FIGS. 26a-26d shows scanning electron microscopy images of nanostructured composite materials: yttrium-stabilized zirconia (FIG. 26a), molecular ratio metals 8:92 (YSZ); lanthanum strontium cobaltite (FIG. 26b), molecular ratio metals 4:1:5 (LSC); lanthanum strontium manganite (FIG. 26c), molecular ratio metals 40:10:50 (LSM); and lanthanum strontium cobalt ferrite (FIG. 26d), molecular ratio metals 1:5:3:3 (LSCF).

### Effect of Support

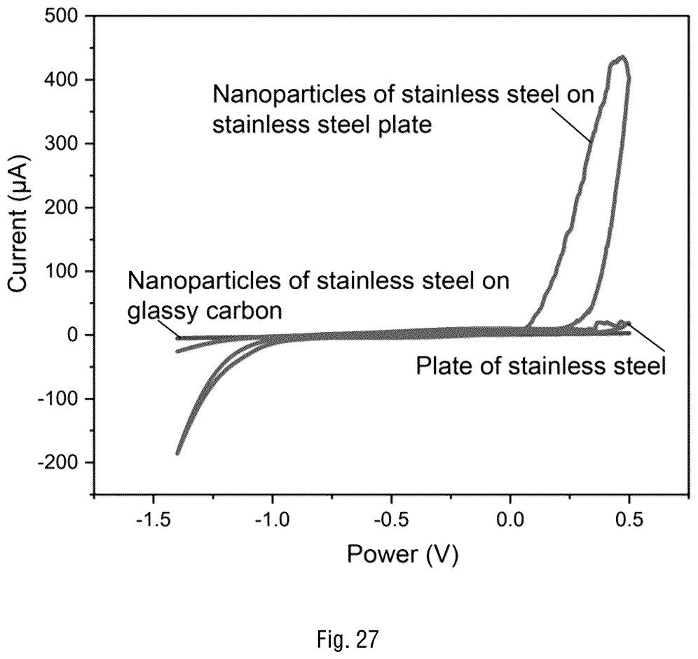

To understand the effect of support on the nanostructured materials, electrochemical analysis was done using nanostructures of stainless steel on an inert support (glassy carbon) and on an active support (stainless steel). The results are shown in FIG. 27 showing cyclic voltammograms of nanostructured stainless steel on glassy carbon, and stainless-steel supports, and a reference of stainless steel with no nanoparticles of stainless steel. These results clearly indicate a synergistic effect for the stainless steel-supported stainless-steel nanoparticles, far exceeding the stainless-steel components on their own. Cyclic voltammetry was performed in a 3-electrode cell, using nearshore seawater, a graphite counter electrode, Ag/AgCl reference electrode, and was recorded in a potential window between −1.4 to 0.5 V. The experiments were repeated in artificial seawater where appropriate amounts of NaCl, MgO, and CaOH were added to double distilled water to mimic the ionic composition of seawater and confirm the results presented in this figure.

### Splitting Water for Hydrogen Production

Hydrogen has been investigated as an attractive alternative to fossil fuels, particularly, over the past decade and considered to have the potential to provide a supply of clean, reliable, and affordable energy to meet the growing demands of earth population and economies. However, there have been problems associated with the commercialization of hydrogen fuel, one of them is the inability to economically generate clean and pure hydrogen in a cost-effective way.

One approach to hydrogen production involves splitting water using electricity, i.e., water electrolysis. In this approach, electric current is passed through water which splits water into hydrogen and oxygen. In certain embodiments, electricity-induced splitting of water is conducted using the nanostructured electrode of the invention in alkaline, neutral, or acidic pH media mediated with a polymer exchange membrane (PEM) to induce the water electrolysis. These methods are demonstrating the potential to produce energy source in a process clean from greenhouse gas emission or toxic by-products, especially if the electric current is generated using renewable energy sources.

The capital costs for current electrolysers technology are a significant barrier to hydrogen production. The high capital costs of current electrolysers are mostly due to deployment of expensive noble metal-based electro-catalysts (Pt group metals) and/or low efficiency systems. Pt group metals are well known for oxygen evolution reaction (OER) catalysts used with anode electrodes in alkaline media and PEM-based water electrolysis. However, the noble-metal based electro-catalysts undergo electrochemical or mechanical degradation under extreme and highly corrosive electrochemical environments, especially in acid assisted water electrolysis which reduces the performance with time and reduces the service life of the electrode during OER.

Electrode-catalyst capable of demonstrating activity and stability comparable to a pure noble metal catalyst for a reduced cost is essential for leading the industry to a hydrogen-based economy. Thus, one of the objectives of the described invention is to present a highly efficient and stable electro-catalyst design which includes a combination of non-noble metals to replace the expensive noble metals required for use as electrodes in water electrolysis.

Today's solutions are limited due to the very high costs for the electrocatalysts and the dependency on noble metals. More than that the need to work in a specific acidic or alkaline media is limiting the process to a “chemically-pre-treated water”, in comparison to working in natural/changing water environments that will eliminate costs and operation while opening new sources of water, like natural seawater, which is the most abundant source of water.

One of the aspects of the present invention is therefore directed at a novel combination of inexpensive-materials as nano-structured catalysts coupled with a cooperative electrode-support material for OER and hydrogen evolution reaction (HER) electrodes with an overtaking efficiency compared to the current best performing noble-materials. By using stainless steel (AISI 304/316 as a non-limiting example) electrode support and depositing, for example, via spark ablation, the same material as nanoparticles in a range of 2-40 nm, an inexpensive nanostructured electrode of the present invention has been created. This electrode was capable to out-perform noble-metal-based electrodes.

As noted above, the application of the nanostructured electrode of the present invention for hydrogen production is one of the aspects of the present invention. In other aspects of the present invention, the nanoparticles obtained in the present invention are used for the production of both anode and cathode nanostructured electrodes, which are used in several applications:
1) Electrodes for all types of water electrolysis (specifically OER and HER electrodes).
2) The electrodes can act as an electrocatalysts for chloralkaline processes, leading to chlorine and caustic soda production.
3) These electrodes can also fit to become the leading catalyst for environmental control applications, such as DE-Noxing (SCR reaction), VOCs control, CO oxidation (near engines and chimneys), plastic depolymerization and plastic pyrolysis.

The nanostructured electrodes of the present invention were tested in a specific water electrolysis reactions and mixtures, deionized water, tap water and seawater.

Nanoengineering of stainless-steel nanoparticles via spark ablation has never been done before, that together with a vast number of the conducted in-house experiments for water electrolysis led the inventors to the present aspect of the invention, i.e., to combine the nanoparticles with this specific electrode platform material and surprisingly observe the synergetic phenomena. In fact, it was indeed an unexpected and surprising finding that the combination between the nano-catalyst and the present electrode is creating a synergetic effect which exceeds 100× the combine activity of each component alone.

To sum-up, one of the aspects of the present invention is the very active and stable stainless-steel nanostructured electrodes having the electrolytic activity 100× more than any other stainless-steel electrode. According to the present invention, the nanostructured electrode of the invention matches and exceeds Pt group metals properties, for various types of reactions with much cheaper materials (less capital and maintenances costs for electrodes), with a production process for the electrodes which is easily scalable.

1.-22. (canceled)

23. A nanostructured electrode comprising nanoparticles of conductive material deposited on a conductive electrode support, wherein said nanoparticles are characterised by a particle size of about 20.0 nm or less and a particle size distribution having a tuneable standard deviation which, when measured with a differential mobility analyser configured to select particle sizes, is within the range of approximately ±0.1 nm to ±1.0 nm, said tuneable standard deviation being adjustable by tuning a sheath flow rate of a carrier gas in the range of approximately from 1 ml/min to 25 ml/min in said differential mobility analyser, thereby tuning the standard deviation of a Gaussian distribution of the nanoparticle sizes from approximately ±0.1 nm to approximately ±2 nm.

24. The nanostructured electrode of claim 23, wherein said electrode is produced by a method of spark ablation.

25. The nanostructured electrode of claim 23, wherein said electrode is produced by a method of spark ablation combined with a differential mobility analyser to produce a particle size distribution having a tuneable standard deviation within the range of ±0.1 nm to ±1.0 nm.

26. The nanostructured electrode of claim 23, wherein said electrodes have a surface covered with plurality of craters, said craters are defined as circular or oval-shaped corrugations having a valley surrounding the nanoparticle leading to an apex in height of up to 5 nm, to the likeness of a meteor impact, in which the nanoparticle sits, with the corrugation having a diameter of up to 3 times the diameter of the nanoparticle as measured by an AFM (atomic force microscope).

27. The nanostructured electrode of claim 23, wherein said nanoparticles have a disk-like shape with a ratio of height to base of said disc being lower than 0.5, and down to 0.05 as measured by an AFM (atomic force microscope).

28. The nanostructured electrode of claim 23, wherein said conductive material of the nanoparticles is selected from yttrium (Y), yttria-stabilized zirconia (YSZ), zirconium (Zr), nickel (Ni), copper (Cu), platinum (Pt), lanthanum strontium manganite (LSM), praseodymium-doped ceria (PrCeO₂), gadolinium-doped ceria (GdCeO₂), samarium-doped ceria (SmCeO₂), neodymium-doped ceria (NdCeO₂), erbium-doped ceria (ErCeO₂), lanthanum strontium cobaltite (LSC), lanthanum strontium cobalt ferrite (LSCF) and stainless steel

29. The nanostructured electrode of claim 28, wherein said conductive material of the nanoparticles is selected from yttrium (Y), zirconium (Zr), zirconia stabilised with yttrium (YSZ), nickel and stainless steel.

30. The nanostructured electrode of claim 23, wherein said nanoparticles are composite nanoparticles comprised of nickel supported on yttria-stabilized zirconia (Ni@YSZ).

31. The nanostructured electrode of claim 23, wherein said nanoparticles are stainless steel nanoparticles.

32. The nanostructured electrode of claim 23, wherein said conductive electrode support is a solid oxide membrane.

33. The nanostructured electrode of claim 23, wherein said conductive electrode support is a stainless steel.

34. The nanostructured electrode of claim 23, wherein the particle size of said nanoparticles is about 10 nm or less.

35. The nanostructured electrode of claim 23, wherein the particle size of said nanoparticles is about 5 nm or less.

36. A solid oxide electrolyser comprising the nanostructured electrode of claim 23.

37. A fuel cell comprising the nanostructured electrode of claim 23.

38. A method for electrochemical precipitation of salts from water and electrochemical scale removal comprising a step of applying the nanostructured electrode of claim 23 to said water.

39. The method of claim 38, wherein said method for electrochemical scale removal is descaling of water for private and commercial purposes.

40. The method of claim 38, wherein said method for electrochemical scale removal is water pre-treatment for desalination of water.

41. A method for selectively increasing the pH of water comprising a step of applying the nanostructured electrode of claim 23 to said water.

42. A method of hydrogen production comprising a step of applying the nanostructured electrode of claim 23 in an electrolytic hydrolysis of water.
